(19) United States
(12) Patent Application Publication
(10) Pub. No.: US 2001/0039548 A1
(43) Pub. Date: Nov. 8, 2001

(54) File replication system, replication control method, and storage medium

(76) Inventors: Yoshitake Shinkai, Kawasaki (JP); Naomi Yosizawa, Kawasaki (JP); Kensuke Shiozawa, Kawasaki (JP)

Correspondence Address: STAAS & HALSEY LLP, 700 11TH STREET, NW, SUITE 500, WASHINGTON, DC, 20001, US

(21) Appl. No.: 09/817,288

(22) Filed: Mar. 27, 2001

(30) Foreign Application Priority Data
Apr. 27, 2000 (JP) 2000-126797

(51) Int. Cl. G06F 17/30; G06F 15/167

(52) U.S. Cl. 707/201; 709/213; 707/10; 707/9

(57) ABSTRACT

A token managing portion manages an access request for a shared file. An IO request intercepting portion asks the token managing portion to acquire access permission for the shared file in response to an access request for the shared file in the node itself. The token managing portion notifies the IO request intercepting portion of a node that has update permission in response to the access request of the IO request intercepting portion. The IO request intercepting portion asks the node that has the update permission to access the shared file when the IO request intercepting portion is not capable of acquiring the access permission. Thus, with a file consistent assurance control, a file replication system as an improved application of a file replication can be accomplished.

### BACKGROUND OF THE INVENTION

1. Field of the Invention

The present invention relates to a file replication technology for dynamically distributing file replications of a file to a plurality of computers so as to distribute the load of the system, to improve the system performance, and to enhance the system reliability.

2. Description of the Related Art

As a method for dynamically distributing the same data to a plurality of computer systems (nodes) connected through a network and for improving the reliability thereof, a file replication technology is known.

In the file replication technology, when a file is updated at a specific node, the updated content of the file is detected and only the changed data is propagated to a predetermined node group so that the file is updated.

There are two types of propagating methods. The first method is a synchronous method. In the synchronous method, when a user program is notified that an update command has been completed, it is assured that changed data has been propagated to other nodes. The second method is an asynchronous method. In the asynchronous method, the updated content is stored in the system. At a proper timing, the updated content is propagated to other nodes. In the asynchronous method, although the response latency is low, when the user program is notified that the update command has been completed, it is not assured that the update content has been propagated to other nodes.

Moreover, in the conventional file replication method, since the identity and consistency of data stored in each node are not assured, the following problems result in.

In the asynchronous method, when a plurality of nodes consecutively update related files, the propagation order of the updates is not assured. Thus, there is a critical problem that inconsistent data containing old data and new data is viewed by a node that performs only referring the data.

In addition, when a plurality of nodes update the same file almost at the same time (including a situation where they update the same file at intervals of a sufficient time period in real time), each node stores different data. As a result, the file will be destroyed.

As with the asynchronous method, even with the synchronous method, when two nodes update the same file almost at the same time, the file may be destroyed. For example, when nodes A and B update the same area of a file almost at the same time, they have different data. In such a case, these nodes perform respective processes based on different data, which the respective nodes themselves have. As a result, the nodes A and B perform inconsistent processes.

Thus, in the conventional file replication method, only one statically designated node is permitted to update a file. The other nodes are permitted to only reference the file. Such a method is disclosed, for example, in Japanese Patent Laid-Open Publication No. 9-91185 titled “Distributed Computing System”. In this method, a write token and a read token are prepared. With a write token, a node can update and reference the data of a file of the node itself. With a read token, the node can only reference the data of the file of the node itself. When there is a node having a write token, other nodes are prohibited from having both a read token and a write token. In addition, all update requests are synchronously performed so as to solve the problem of inconsistency due to simultaneous updates.

However, in such a disclosed method, since a file is always synchronously updated, there is a problem of a high response latency. In addition, when there are a plurality of nodes that access the same file and at least one of them updates the file, whenever the application program issues an IO request, a process for acquiring a token for accessing the data of the node itself should be performed. Thus, the overhead of the system becomes very large.

In the conventional replication method, including this method, it is assumed that each node accesses the data of the node itself. Thus, when a new node is joined to a system, only after the new node has received the data of all files of other nodes of the system, the consistency of data is assured. As a result, when a new node is joined to the system, the new node cannot be immediately operated for business. In addition, while the data of all files of the other nodes of the system is being transferred into the new node, the other nodes cannot update the data. In other words, the operation of the system stops for a long time.

### SUMMARY OF THE INVENTION

An object of the present invention is to provide a file replication system for detecting a node that has the latest data, propagating a read/write request to the detected node, asking the node to access the data so as to minimize the influence on the system operation of a newly joined node.

Another object of the present invention is to provide a file replication system that accomplishes high-speed replications that allow data to be updated almost at the same time in a plurality of nodes even if updated data is asynchronously propagated.

Another object of the present invention is to provide a file replication system for controlling the reflection of an update request that is asynchronously propagated to a file using a dependency vector composed of an update number representing the local order of a node that issues a write request and an update number of another node to which the write request is issued so as to assure the logical order of file update even if the system is degenerated.

The present invention is a file replication system having a plurality of nodes connected to a network, shared files being distributed to the nodes.

To solve the problem described above, a first node of the nodes comprises a first token managing portion and an IO request intercepting portion.

The first token managing portion asks a second node of the nodes to acquire access permission for a shared file when an access request takes place in the first node.

The IO request intercepting portion accepts an access to a shared file that takes place in the first node, asks the first token managing portion to acquire the access permission for the access request, and asks a node that has update permission for the shared file when the first token managing portion is not capable of acquiring the access permission.

A second node comprises a second token managing portion.

The second token managing portion notifies the first node of a node that requests access permission for a shared file as a response message when another node has update permission for the shared file.

As a result, each node can access the data of a node that has the latest data. In addition, each node can access consistent data.

The node may further comprise a changed data notifying portion for propagating the updated content of the shared file to another node along with information that represents a dependent relationship with another update and a received data processing portion for reflecting the updated content on the shared file while assuring the order of the update based on the dependency relationship.

As a result, even if the file update requests arrive irrespective of the file update order, it is assured that the shared data is updated in order.

The node may further comprise a system structure managing portion for performing the restoration process of the data of a shared file of the node itself when it is newly joined to a system, wherein while the system structure managing portion is restoring the shared file, when an access request for the shared file takes place in the node itself, the IO request intercepting portion asks another node that shares the shared file to access the shared file.

As a result, a newly joined node can perform a process without need to wait for the completion of the updating process of a shared file.

These and other objects, features and advantages of the present invention will become more apparent in light of the following detailed description of a best mode embodiment thereof, as illustrated in the accompanying drawings.

### BRIEF DESCRIPTION OF DRAWINGS

FIG. 1 is a block diagram showing the theory of the present invention;

FIG. 2 is a schematic diagram showing the structures of systems;

FIG. 3A is a schematic diagram showing a process performed among nodes that access an object group;

FIG. 3B is a schematic diagram showing a process performed between a newly joined node and another node of a system;

FIG. 4 is a block diagram showing the structure of a node that composes a system according to an embodiment of the present invention;

FIG. 5 is a schematic diagram showing an example of the structure of a system state table;

FIG. 6 is a schematic diagram showing an example of the structure of an internal control table;

FIG. 7 is a flowchart showing a process of a system structure managing portion in the state where a join command is issued;

FIG. 8 is a flowchart showing a process of the system structure managing portion in the state where a join process is performed;

FIG. 9 is a flowchart showing a join request acceptance process of the system structure managing portion;

FIG. 10 is a flowchart showing a process of the system structure managing portion of a node that has received a join message;

FIG. 11 is a flowchart showing an equality restoration process of the system structure managing portion;

FIG. 12 is a flowchart showing the system structure managing portion of a node that has received an equality restoration transfer request;

FIG. 13 is a flowchart showing a process of the system structure managing portion of a node that has received an equality restoration completion message;

FIG. 14 is a flowchart showing a process of the system structure managing portion of a node that has entered a leave command;

FIG. 15 is a flowchart showing a process of the system structure managing portion of a node that has detected another node that had been broken away the system;

FIG. 16 is a flowchart showing a process of an IO request intercepting portion;

FIG. 17 is a schematic diagram showing an example of the structure of a token control table;

FIG. 18 is a flowchart showing a process of a token managing portion of a token managing node;

FIG. 19 is a flowchart showing a write token acquisition request process of the token managing portion;

FIG. 20 is a flowchart showing a read token acquisition request process of the token managing portion;

FIG. 21 is a flowchart showing a token release/collection request process of the token managing portion;

FIG. 22 is a flowchart showing a process of a write token holding node that has received a write token collection request that is issued in the structure where a node does not spontaneously released an unnecessary token;

FIG. 23 is a flowchart showing a process of a changed data notifying portion;

FIG. 24 is a flowchart showing a calling process of the changed data notifying portion for an IO request intercepting portion/received data processing portion;

FIG. 25 is a flowchart showing a sync request process of the changed data notifying portion;

FIG. 26 is a schematic diagram showing an example of the structure of an update propagation transmission queue;

FIG. 27 is a flowchart showing a reset request process of the changed data notifying portion;

FIG. 28 is a flowchart showing an FSYNC request process of the changed data notifying portion;

FIG. 29 is a flowchart showing a process of a received data processing portion;

FIG. 30 is a flowchart showing an update request process of a received data processing portion;

FIG. 31 is a schematic diagram showing an example of the structure of a real state reflection delay queue;

FIG. 32 is a flowchart showing a read/write request process of the received data processing portion;

FIG. 33 is a flowchart showing a reset request process of the received data processing portion;

FIG. 34 is a flowchart showing an equality restoration data process of the received data processing portion;

FIG. 35 is a schematic diagram showing an example of a dependency vector added to response messages of a write request and a read request;

FIG. 36 is a schematic diagram showing the determination process of the received data processing portion using the dependency vector;

FIG. 37 is a schematic diagram showing the assurance of the order of update requests that have a dependent relationship;

FIG. 38 is a schematic diagram showing a process of the node itself for a write request in the case that the real state reflection delay queue contains an update request for the same file;

FIG. 39 is a block diagram showing the structure of a computer system that operates as a node; and

FIG. 40 is a schematic diagram showing an example of a storage medium.

### DESCRIPTION OF PREFERRED EMBODIMENT

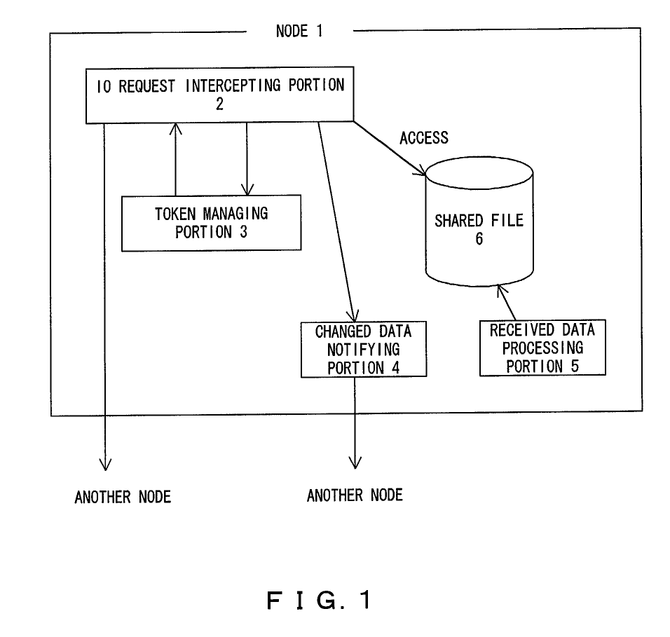

FIG. 1 is a block diagram showing the theory of a node according to the present invention.

The node 1 according to the present invention is connected to another node through a network. The node 1 has a file 6 shared with another node. The node 1 comprises an IO request intercepting portion 2 and a token managing portion 3.

The token managing portion 3 manages access requests for a shared file 6.

The IO request intercepting portion 2 asks the token managing portion 3 to permit access to the shared file 6 in response to an access request for the shared file 6 in the node itself. When the token managing portion 3 permits the access, the IO request intercepting portion 2 access the shared file 6.

When another node has an update permission for the shared file 6, the token managing portion 3 notifies the IO request intercepting portion 2 of the node that has the update permission for the shared file 6 in response to the access request. When the IO request intercepting portion 2 cannot acquire the access permission, it asks the node that has the update permission to access the shared file 6.

As a result, each node 1 can access the data of a node that has the latest data. In addition, each node can access consistent data.

The node 1 may further comprise a changed data notifying portion 4 for propagating the updated content of the shared file 6 to another node along with information that represents a dependent relationship with other updates, and a received data processing portion 5 for reflecting the updated content on the shared file while assuring the order of the update based on the dependency relationship.

As a result, even if file update contents arrive irrespective of the file update order, it is assured that the shared data is updated in right order.

The node 1 may further comprise a system structure managing portion for performing the restoration process of the data of the shared file 6 of the node itself when a node is newly joined to the system, wherein while the system structure managing portion is restoring the shared file, when an access request for the shared file 6 takes place in the node itself, the IO request intercepting portion 2 asks another node that shares the shared file 6 to access the shared file 6.

As a result, a newly joined node can perform a process without need to wait for the completion of the restoration process of a shared file.

Next, with reference to the accompanying drawings, the preferred embodiments of the present invention will be described.

In the file replication system according to the preferred embodiment, a system is composed of a plurality of nodes connected through a network. Each node of the system shares files.

First of all, the structure of the system will be described.

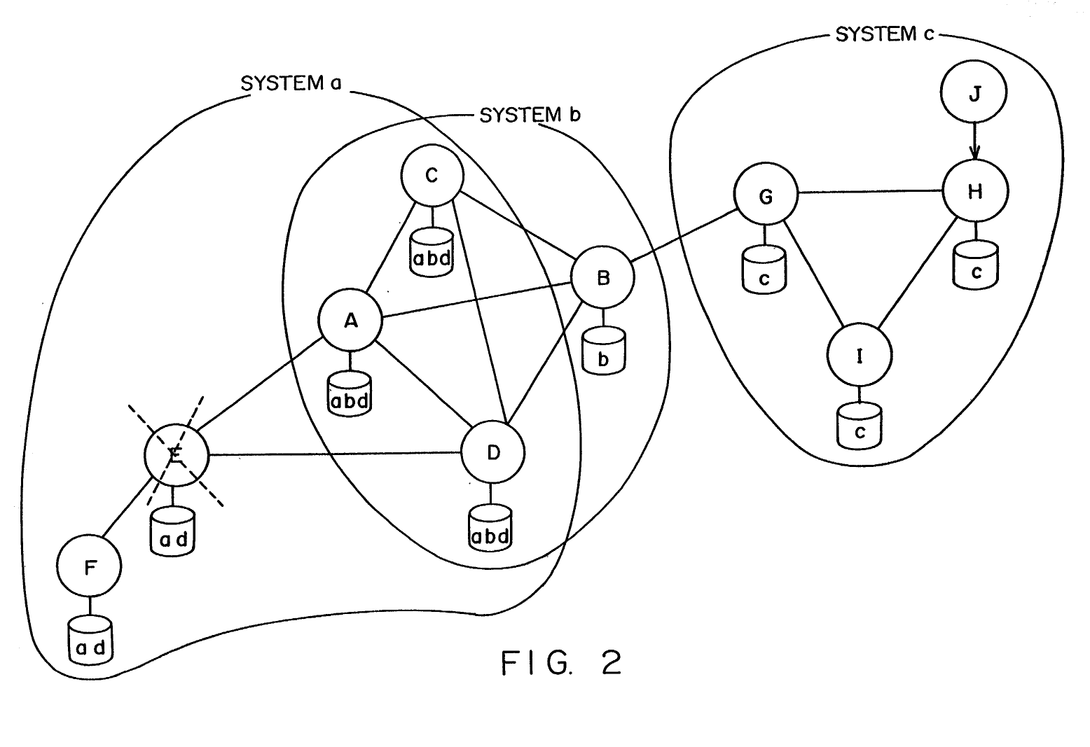

FIG. 2 is a schematic diagram showing a system and a restructure thereof according to the embodiment.

According to the embodiment, a system is composed of a group of nodes that share the same file (group) (hereinafter, at least one file (group) shared in each system is referred to as object group). In FIG. 2, there are three systems. A system a is composed of nodes A, C, E, and F, which share object groups a and d. A system b is composed of nodes A, B and D, which share an object group b. A system c is composed of nodes G, H and I, which share an object group c.

One node of each system manages a read/write token for accessing a shared file. When a system is structured, a predetermined node is designated as a token managing node, or a token managing node is dynamically selected based on a predetermined condition (for example, a node having the minimum network address may be selected as a token managing node).

When a new node is joined to a system or when a system is degenerated due to the defect of a node composing the system or a network, the system is restructured. For example, in the system a shown in FIG. 2, due to the defect of the node E, the nodes E and F are broken away from the system a. As a result, the system a is restructured with the remaining nodes. In the system c, since a node J is newly joined to the system c by a join command, the system c is restructured. When the system c is restructured, an equality restoration process for assuring the consistency of the shared files of the newly joined node is performed.

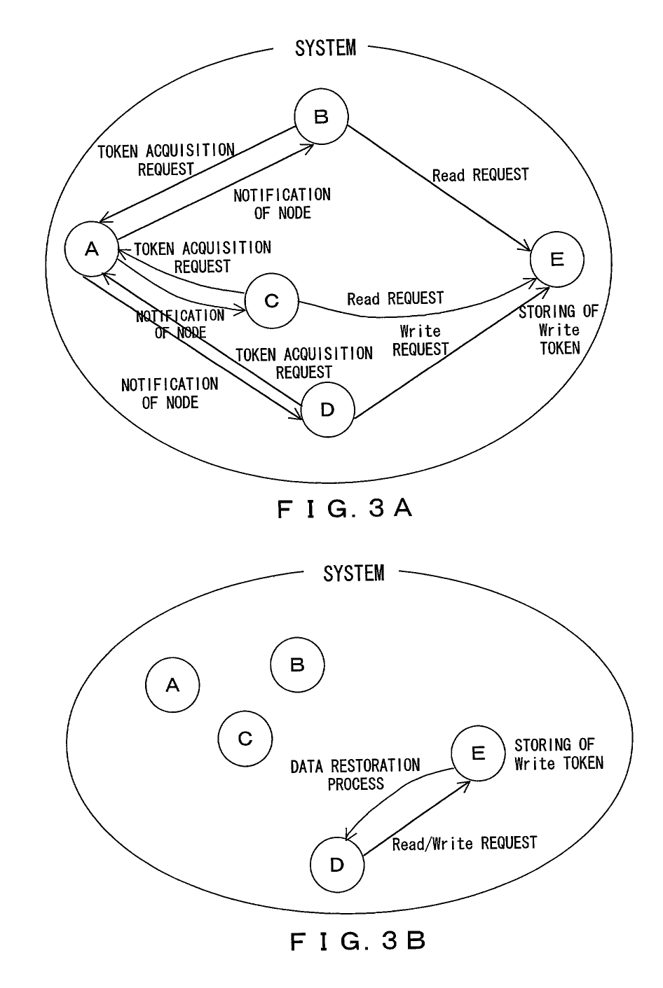

A node may be spontaneously broken away from a system by transmitting a predetermined message to another node of the system besides the leaving of a node by a defect. FIGS. 3A and 3B are schematic diagrams showing basic operations performed among nodes according to the present embodiment.

FIG. 3A shows a process performed among nodes that access an object group. In FIG. 3A, there are five nodes A to E in the same system. Among them, the node A is designated as a token managing node. When a user program of each node issues an access request for a file of the object group, the node issues a read/write token acquisition request to the node A.

Unless the node A has already given a write token to another node, the node A gives the token to the requesting node. When the node A has already given the write token to another node, the node A notifies the requesting node of a node that has the write token, along with a token acquisition failure message. When the requesting node receives the token acquisition failure message, the requesting node asks the notified node to process a read/write request for the file. As a result, the node having the write token processes such requests so that the order of write operation to the file is kept. In FIG. 3A, when the nodes B and C issue read requests (reference requests) and the node D issues a write request (update request), since the node E has a write token, the node A notifies each node that the node E has the write token, along with a token acquisition failure message in response to token acquisition requests therefrom. As a result, each node transmits a read/write request for the file to the node E. The node E performs a read/write operation for the file in such a manner that the orders of write requests to the file is kept.

According to the present embodiment, in such a manner, when a node issues an access request for a shared file, it is notified that a node has a write token. In other words, a node that issues an access request is notified of a node that has the latest data of the shared file. As a result, a node that accesses a shared file can always access the latest data thereof.

In addition, each node can continue a process without need to wait until it acquires a token even if it fails to acquire it. In addition, a plurality of nodes can access the same file at the same time. Thus, a system having a low response latency can be accomplished.

Since a node that has a write token also performs the process of an update request that takes place in another node, each node can view consistent data.

In addition, when access requests that take place at the same time are processed, it is not necessary to perform the token collection process of each node. Thus, the overhead of the system can be reduced.

Next, a new join process to a system according to the present embodiment will be described.

FIG. 3B is a schematic diagram showing processes performed between a newly joined node and another node in a system.

According to the present embodiment, each node has information that represents the lateness of data. When a node is newly joined to a system, the node compares a plurality of pieces of information that represents the lateness of data possessed by each node. Only when data is updated while the new node is being broken away from the system, the new node performs a restoration process. While the new node is restoring data, the node starts a user program and performs a normal operation. When the user program issues an access request for a file, the new node issues a read/write request to another node of the system and asks it to access the file. In FIG. 3B, before completing the file restoration process, the node D that has newly joined the system starts the user program. While the node D is restoring the file, when the user program issues an access request for a file of the object group, the node D asks the node E that has a write token to access the file.

As described above, according to the present embodiment, before completing a file restoration process, a newly joined node can access a file. Thus, just after a node joins a system, the node starts a program and operates a normal operation.

Next, with reference to the accompanying drawings, an embodiment that accomplishes the theory described above will be described.

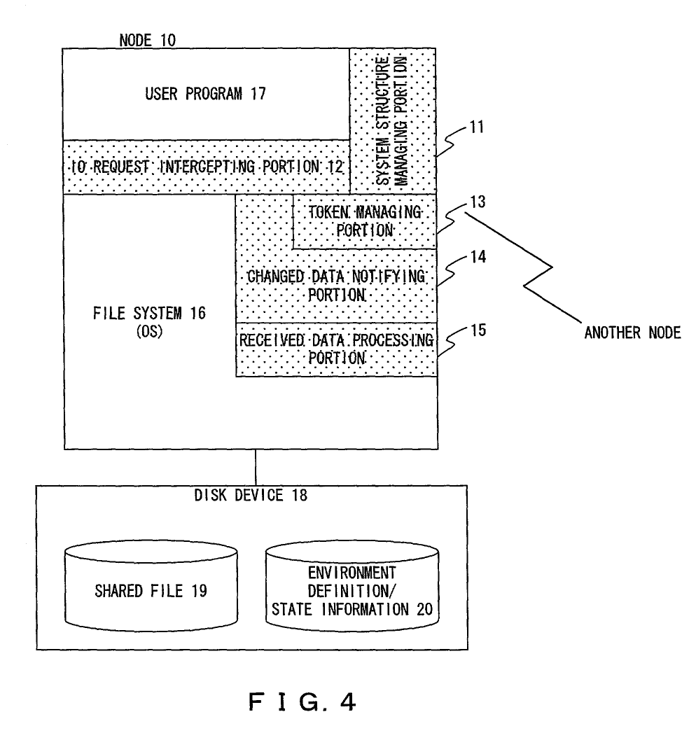

FIG. 4 is a block diagram showing the structure of one of a plurality of nodes that structure a system according to the embodiment.

Each node 10 shares an object group disposed in a plurality of disk devices of the information processing system. Each node 10 comprises a system structure managing portion 11, an IO request intercepting portion 12, a token managing portion 13, a changed data notifying portion 14 and a received data processing portion 15. A program loaded in the memory of each node accomplishes each structural portion. To accomplish a sufficient process speed, a part of the structural portions may be composed of hardware. The local disk device 18 of the node 10 stores a shared file 19 and environment definition/state information 20. The file 19 is shared in the same system. The environment definition/state information 20 is definition information necessary for structuring a system.

Among those structural portions, the IO request intercepting portion 12 operates as a part of an operating system (OS). The IO request intercepting portion 12 receives an input/output instruction issued by a user program 17 and sends the input/output instruction to the file system of the OS.

According to the embodiment, the IO request intercepting portion 12 is separated from the file system 16 of the OS. Alternatively, the IO request intercepting portion 12 may be contained in the file system 16. In addition, the other structural portions may be composed of the elements of the OS. Alternatively, those structural portions may be accommodated into the OS as an application program.

Next, each structural portion of each node will be described in detail.

[System Structure Managing Portion]

The system structure managing portion 11 plays the role of maintaining a system structure state at the time of node starting and system restructuring, of designating target files and a propagation mode, of managing the state of a system at the time of degeneration due to a node defect, new node joining, etc., of synchronizing a node with other nodes at the time of system restructuring (synchronous restoration), of initially synchronizing a newly joined node with other nodes of a system (equality restoration process), of monitoring the state of a node, and of interfacing with the operator.

In addition, the system structure managing portion 11 performs the node defect monitor process of each node composing a system after it is joined to the system by a join command until it is broken away from the system by a leave command. It will be described later.

When a program that accomplishes the file replication system gets started as a part of the system starting process, an environment definition/state file is read so as to acquire information about at least one file group that belongs to an object group, a node group that distributes the object group, and a propagation mode of updated data.

The environment definition/state file is composed of system state tables for individual object groups.

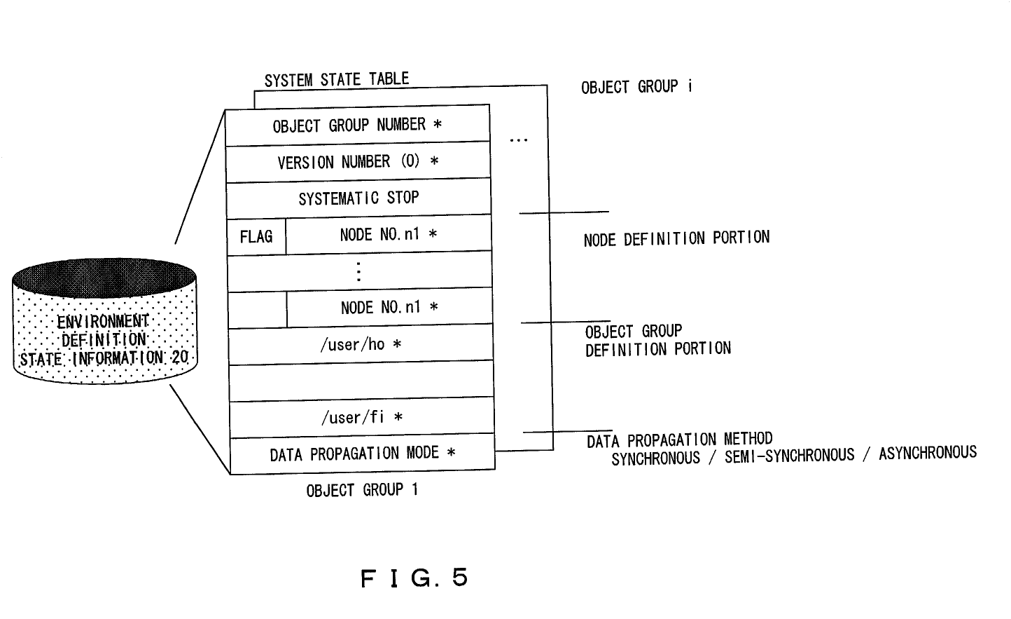

FIG. 5 is a schematic diagram showing an example of the structure of a system state table.

Each system state table records information about the structure of each object group, etc., for each object group. Each system state table contains an object group number for identifying the object group of which the information is recorded in this table, a system version number, a systematic stop flag, a node defining portion, an object group definition portion, and updated data propagation mode information. The systematic stop flag represents whether or not the node itself systematically stopped last time. The node defining portion is composed of an array whose member has the node number of each node composing a system and a flag representing whether or not the node systematically stopped last time. The object group defining portion identifies each file that belongs to the current object group. The updated data propagation mode information identifies a propagation mode (synchronous mode, semi-synchronous mode, or asynchronous mode: these modes will be further described in detail later) of each file that belongs to the current object group. The “systematic stop” represents a method for breaking away a node from a system that all nodes belonging to the system simultaneously stop the process of a file belonging to the object group in synchronization with other nodes, when service is stopped, for example, for winter holidays.

Information elements with an asterisk (*) in FIG. 5 are information items that are initially specified by a user and are changed by the system structure managing portion 11 as the need arises. Information elements without an asterisk (*) are information items that are set and changed by the system structure managing portion 11 without intervention by a user.

The environment definition/state information 20 is composed of a plurality of system state tables corresponding to a plurality of object groups, and it is possible to set the information for each object group.

In FIG. 2, the node A has system state tables for three object groups a, b, and d. Thus, an object group and a transfer mode (synchronous mode, asynchronous mode, and semi-synchronous mode) can be assigned for each object group. For example, in FIG. 2, the nodes A, C, D, E, and F are assigned to the object groups a and d, whereas the nodes A, B, C, and D are assigned to the object group. Based on the importance of data, for example, a synchronous mode is set in the most important object group a; an asynchronous mode is set in the least important object group c; and a semi-synchronous mode is set in the intermediately important object group b.

The system structure managing portion 11 reads the environment definition/state information 20, stores the internal control tables in the memory for each individual object table, and sets user specified data to each structural portion.

Each internal control table is stored in the memory of a node that has information about an object group specified by the user.

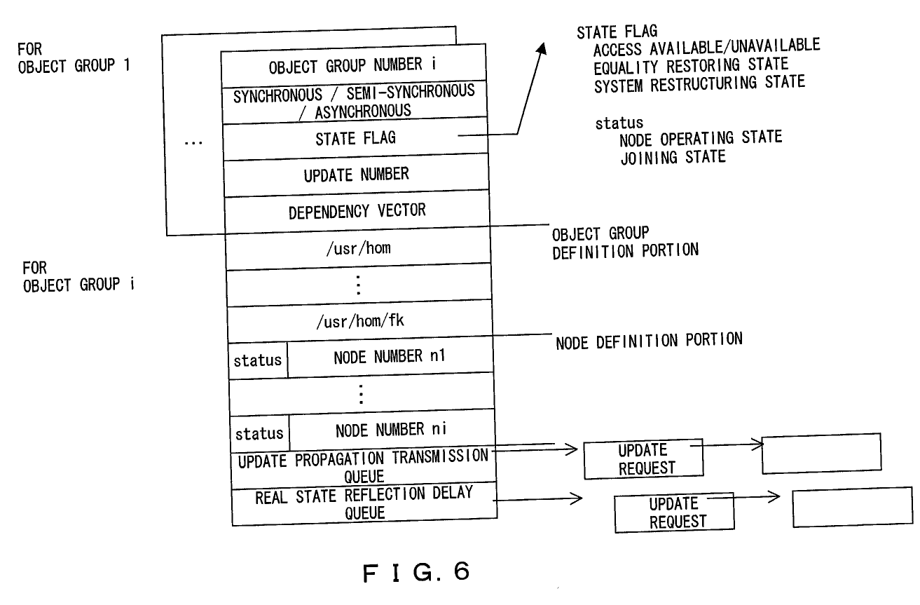

FIG. 6 shows an example of the structure of each internal control table.

Each internal control table shown in FIG. 6 records an object group number for specifying each object group, an updated data propagation mode (synchronous mode, asynchronous mode, or semi-synchronous mode), a state flag, an object group definition portion, a node defining portion, a pointer to an entry of an update propagation transmission queue, and a pointer to an entry of a real state reflection delay queue. Among them, as with the object group defining portion of a system state table, the object group defining portion stores a set of the top path names of file groups that belongs to the current object group and represents that file groups beginning with those specified path names belong to the current object group. The node defining portion stores an array whose member has a node number and a status field that represents a node group and its operating state (operating state, joining state, etc). The update propagation transmission queue and the real state reflection delay queue will be described later.

The state flag is a set of flags that represent an access-available/unavailable state (of a file that belongs to the current object group), an equality restoring state, a system restructuring state, etc. Each system structure management portion shown in FIG. 4 switches 1/0 of the corresponding bit of the state flag so as to notify another system structure management portion of the state. In the initial state, since another node may have created a system and has updated a file, the node itself is prohibited from accessing all files that belong to the object group.

After the initial process is completed, the system structure managing portion 11 waits until the operator inputs a command for the object group.

1) Join command

To activate the object group, the operator inputs a join command.

When the join command is input, the system structure managing portion 11 exchanges data with other nodes and joins the system of an object group designated with the join command. When the join command is designated with an option “single” that permits a system to be individually created, unless the system of this object group has been created, a new system is created.

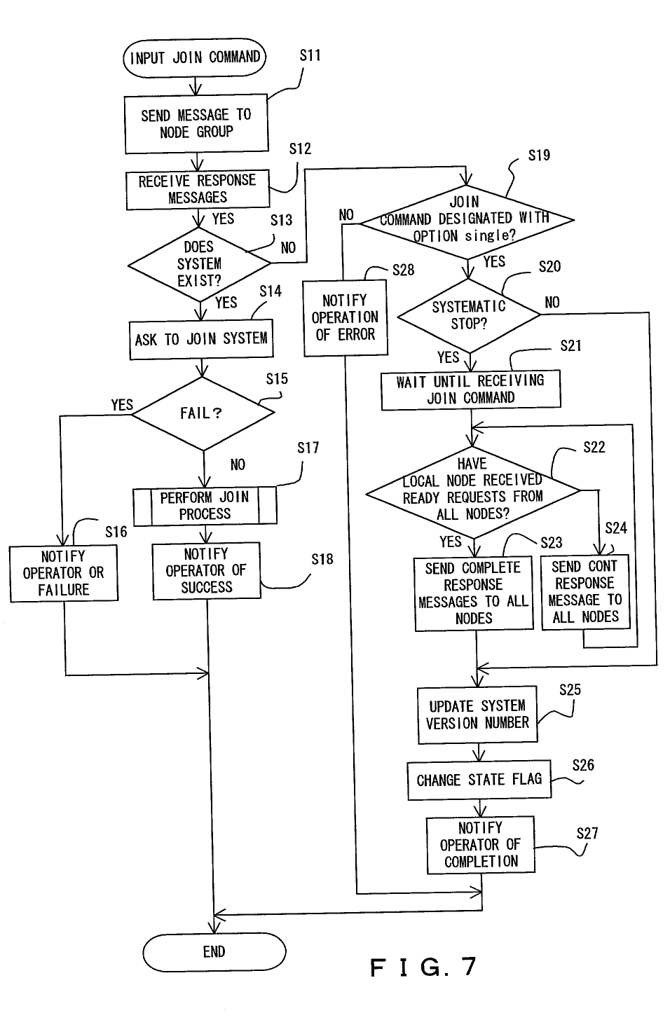

FIG. 7 is a flow chart showing the process of the system structure managing portion 11 in the case where a join command is input.

When a join command is input, the system structure managing portion 11 consecutively sends messages to other nodes that share an designated object group along with the join command (at step S11) and receives response messages therefrom (at step S12).

The system structure managing portion 11 judges from the response messages of the nodes whether the system of the designated object group has been created by another node. When another node has created the system of the designated object group (namely, the judgment result at step S13 is Yes), the system structure managing portion 11 sends a join request to the node and asks it to perform a join process to the existing system (at step S14).

When the system structure managing portion 11 receives a join failure message in response to the join request from the node (namely, the judgment result at step S15 is Yes), the system structure managing portion 11 notifies the operator that the node itself has failed to join the system (at step S16). Thereafter, the system structure managing portion 11 terminates the process. When the system structure managing portion 11 does not receive a join failure message from the node (namely, the judgment result at step S15 is No), the system structure managing portion 11 performs a join process (that will be described later) (at step S17) and then returns a join success message to the operator (at step S18).

When the system of the designated object group has not been created by another node (namely, the judgment result at step S13 is No) and the join command is designated with the option “single” (namely, the judgment result at step S19 is Yes), the node itself creates the system of the designated object group that consists of only the node itself.

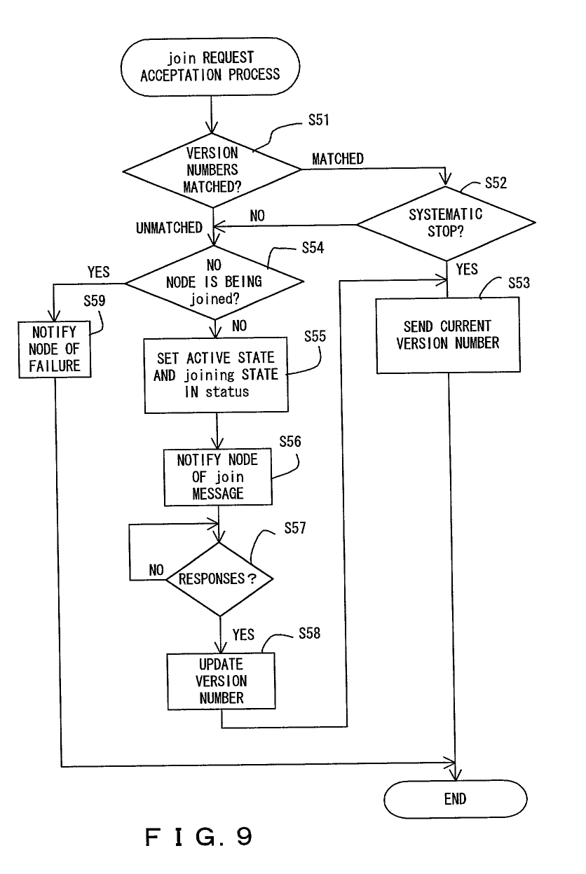

At that point, the system structure managing portion 11 detects information in the system state table. When the systematic stop flag of the system state table represents the systematic stop state and the system structure managing portion 11 judges that the final system state is a systematic stop state (namely, the judgment result at step S20 is Yes), the system structure managing portion 11 waits until other nodes that have joined the system and systematically stopped last time ask the node itself to join a new system (at step S21). The system structure managing portion 11 sequentially performs the join request acceptance processes, which will be described later, (see FIG. 9) of nodes that have sent join requests, and sends the version number of a system that the nodes belong to.

As a result, when the system structure managing portion 11 has received ready requests from all the nodes (namely, the judgment result at step S22 is Yes), the system structure managing portion 11 sends complete response messages to all the nodes (at step S23). When the system structure managing portion 11 has not received ready request messages from all the nodes (namely, the judgment result at step S22 is No), the system structure managing portion 11 sends cont response messages to the nodes in response to the ready requests (at step S24) and waits until the system structure managing portion 11 receives ready requests from all the nodes.

After the system structure managing portion 11 sends complete messages to the nodes in response to the ready requests or when the systematic stop flag of the system state table represents that the node itself did not systematically stop last time (namely, the judgment result at step S20 is No), the system structure managing portion 11 increments the system version number of the corresponding system state table of the environment definition/state information 20 by “1” (at step S25), changes the state flag of the internal control table to an access-available state (at step S26), and notifies the IO request intercepting portion 12 that it can access the object group. Thereafter, in response to the join command the system structure managing portion 11 notifies the operator that the process has been completed (at step S27) and then terminates the process.

When the join command is not designated with an option “single” (at step S19) (namely, the judgment result at step S19 is No), the system structure managing portion 11 notifies the operator of error in response to the join command (at step S28) and then terminates the process.

2) Join Process

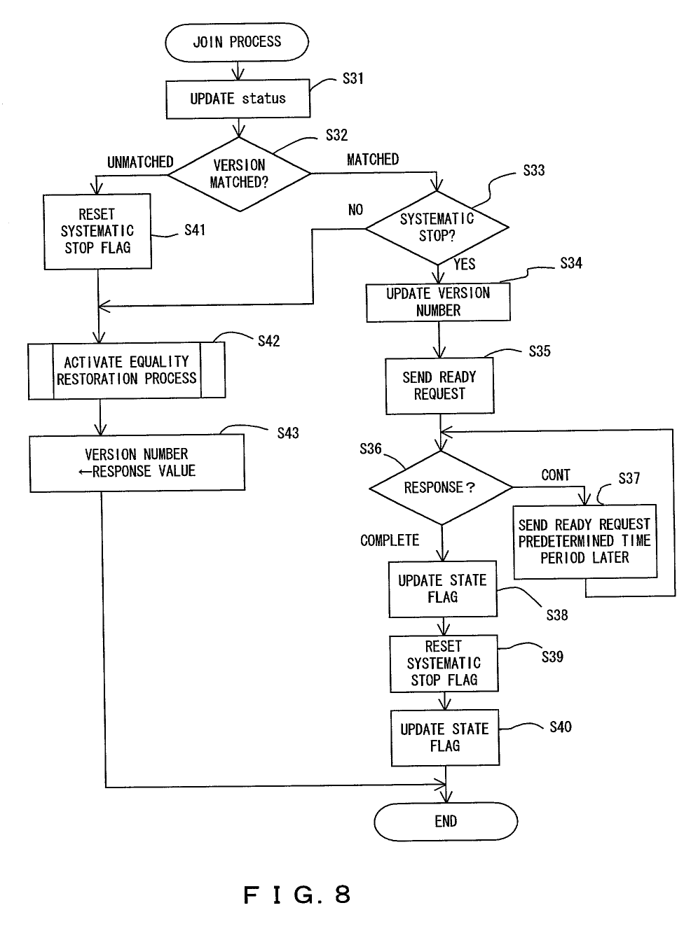

FIG. 8 is a flow chart showing the process of the system structure managing portion 11 at step S17 shown in FIG. 7.

Unless a join failure takes place in response to a join request to a system, a requested node sends the system version number to the system structure managing portion 11. At that point, the system structure managing portion 11 updates the status of the internal control table corresponding to the requesting node, to the joining state, based on node information composing the current system (at step S31) and compares the version number of the notified existing system with the version number of the node itself that will join the system (at step S32). When they do not match, while the node itself is being broken away from the system, the file of the object group may be changed. Thus, the system structure managing portion 11 resets the systematic stop flag (at step S41) and activates an equality restoration process (at step S42). Even if those version numbers match, when the systematic stop flag of the system state table represents a non-systematic stop state (namely, the judgment result at step S32 is “matched” and the judgment result at step S33 is No), since the file of the node itself does not contain the latest data, the system structure managing portion 11 activates the equality restoration process (at step S42). After activating the equality restoration process, without need to wait until it is completed, the system structure managing portion 11 sets the system version number that is received as a response value in the system state table (at step S43), changes the state flag of the internal control table to an access-available state to the object group (at step S40). Thereafter, the system structure managing portion 11 terminates the process.

When the system version number that has been received matches the system version number stored in the system state table (namely, the judgment result at step S32 is “matched”) and the systematic stop flag of the system state table represents a systematic stop state (namely, the judgment result at step S33 is Yes), since the file of the object group of the node itself contains the latest data, it is not necessary to restore the file. Thus, the system structure managing portion 11 does not perform the equality restoration process (at step S42). Instead, the system structure managing portion 11 updates the system version number (at step S34) and regularly sends a ready request to an active node (at step S35). Thereafter, the system structure managing portion 11 waits until all nodes are joined to the system.

When a message in response to the ready request is a cont response message (namely, the judgment result at step S36 is “cont”), the system structure managing portion 11 resends a ready request to an active node (at step S37) and repeats the same process. When the message in response to the ready request is a complete response message (namely, the judgment result at step S36 is “complete”), since all the nodes that had systematically stopped last time have sent a ready request to the requesting node, the system structure managing portion 11 changes the status of each node of the node defining portion in the internal control table to an operating state (at step S38) based on information about an active node composing the requesting system.

Thereafter, the system structure managing portion 11 resets the systematic stop state of the system state table (at step S39) and changes the state flag of the internal control table to an access-available state for the object group (at step S40). Thereafter, the system structure managing portion 11 terminates the process.

3) Join Request Acceptance Process

FIG. 9 is a flow chart showing the join request acceptance process of the system structure managing portion 11.

The join request acceptance process is a process that is performed in response to a join request issued when a new node is requested to join a system at step S14 shown in FIG. 7 and in response to a join request received at the time of waiting at step S21.

When the node itself receives a join request from another node, the system structure managing portion 11 of the node itself compares the system version number of the requesting node received along with the join request, with the system version number of the system state table of the node itself (at step S51). When those system version numbers match (namely the judgment result at step S51 is “matched”) and the systematic stop flag represents a systematic start after a systematic stop (namely, the judgment result at step S52 is Yes), the system structure managing portion 11 sends the current version number of the node itself to the requesting node in response to the join request (at step S53).

When those system version numbers do not match (namely, the judgment result at step S51 is “unmatched”) or even if they match, when the node itself cannot join a system from which the node has been systematically broken away (namely, the judgment result at step S52 is No), the system structure managing portion 11 judges whether the node defining portion of the internal control table represents a node that is being joined (at step S54). When the node defining portion does not represent a node that is being joined (namely, the judgment result at step S54 is Yes), the system structure managing portion 11 notifies the requesting node of the failure as a response (at step S59) and then terminates the process. When the node defining portion represents a node that is being joined (namely, the judgment result at step S54 is No), the system structure managing portion 11 sets the status in the internal control table of the requesting node to an active state and a joining state (at step S55). Thereafter, the system structure managing portion 11 sends join messages to all other active nodes (at step S56). After receiving responses to the join messages (namely, the judgment result at step S57 is Yes), the system structure managing portion 11 updates the system version number (at step S58), sends the current system version number in response to the join requests for the nodes, and terminates the process.

4) Join Notification

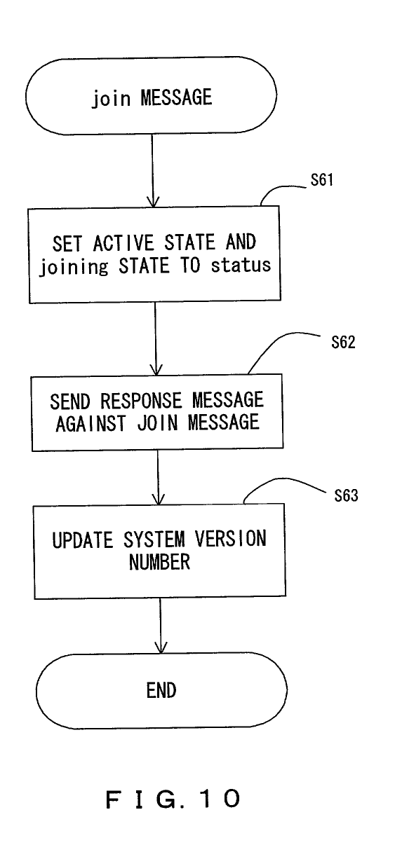

FIG. 10 is a flow chart showing the process of the system structure managing portion 11 of an active node that has received a join message at step S56 shown in FIG. 9.

When the system structure managing portion 11 receives a join message, the system structure managing portion 11 sets an active state and a joining state to the status of a node that has issued the join message (at step S61). The system structure managing portion 11 sends a response message to the requesting node (at step S62). Thereafter, the system structure managing portion 11 updates the system version number of the system state table (at step S63) and then terminates the process.

5) Equality Restoration Process

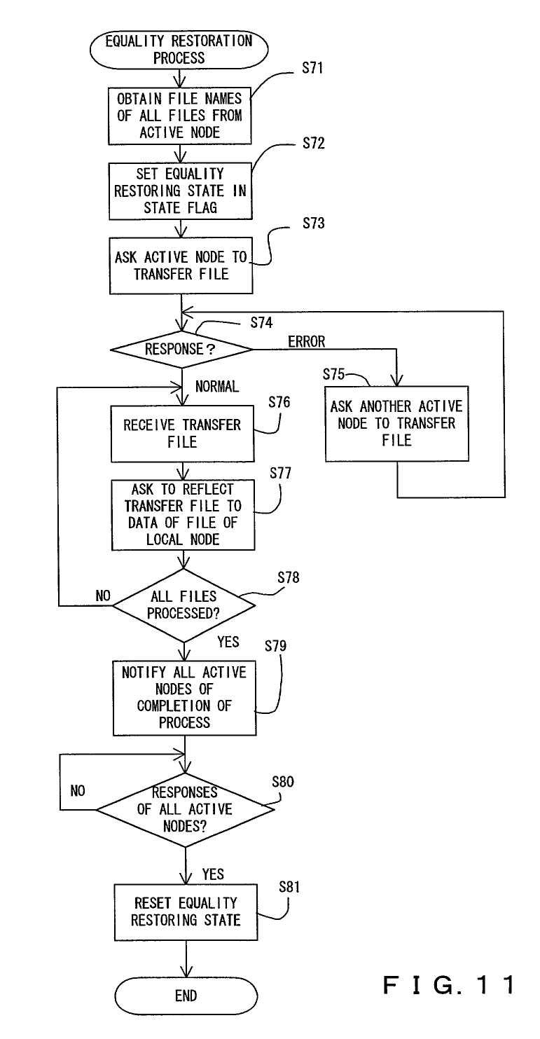

FIG. 11 is a flow chart showing the equality restoration process of the system structure managing portion 11 at step S42 shown in FIG. 8.

An equality restoration process is a process for restoring the data of a file that has been updated while the current node has been being broken away from a system.

When an equality restoration process is activated, the system structure managing portion 11 references the node defining portion of the internal control table and acquires the file names of all files of the object group from one active node of the system (at step S71).

The system structure managing portion 11 sets an equality restoring state in the state flag of the internal control table (at step S72). Thereafter, the system structure managing portion 11 issues a transfer request for the file names acquired at step S71 to the active node of the system (at step S73). This transfer is referred to as equality restoration transfer.

When a response to the file transfer is an error, the system structure managing portion 11 changes the transfer-requested node to another active node of the system and resends a file transfer request to the active node (at step S75).

When the system structure managing portion 11 receives a normal response from the requested node in response to the file transfer request (namely, the judgment result at step S74 is “normal”), the system structure managing portion 11 receives a transfer file (at step S75). The system structure managing portion 11 asks the received data processing portion 15 to reflect the data of the received file on the current file (at step S77). At that point, the propagation of the updated data following a normal file update and the order of the transfer data in the equality restoration process are assured by the changed data notifying portion 14 and the received data processing portion 15. Thus, even if a file is updated while an equality restoration process is being performed, the updated result can be prevented from being lost.

The system structure managing portion 11 receives all the transfer files acquired at step S71 and reflects them on the files of the node itself (namely, the judgment result at step S78 is No). When the system structure managing portion 11 has received all the files and reflected them on the files of the node itself (namely, the judgment result at step S78 is Yes), the system structure managing portion 11 notifies all the active nodes that the equality restoration process has been completed. The system structure managing portion 11 waits for responses from all the active nodes (at step S80). Thereafter, the system structure managing portion 11 resets the equality restoring state of the internal control table (at step S81) and then terminates the process. When the equality restoration process is performed at steps S73 to S78, the system structure managing portion 11 may ask one node to transfer all files at a time. Alternatively, the system structure managing portion 11 may ask a plurality of nodes to transfer files.

6) Equality Restoration Transfer

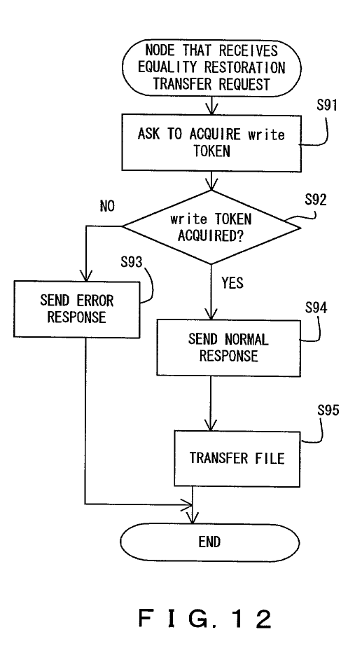

FIG. 12 is a flow chart showing the process of the system structure managing portion 11 of a node that has received an equality restoration transfer request from a node that has performed the equality restoration process at step S73 shown in FIG. 11.

The system structure managing portion 11 of a node that has received an equality restoration transfer request asks a token managing node to acquire a write token (at step S91). When the system structure managing portion 11 cannot acquire a write token (namely, the judgment result at step S92 is No), the system structure managing portion 11 sends an error response to the requested node (at step S93). Thereafter, the system structure managing portion 11 terminates the process.

When the system structure managing portion 11 can acquire a write token (namely, the judgment result at step S92 is Yes), the system structure managing portion 11 sends a normal response to the requesting node (at step S93). Thereafter, the system structure managing portion 11 transfers the requested file data to the requesting node through the changed data notifying portion 14 (at step S95) and terminates the process.

7) Equality Restoration Completion Message

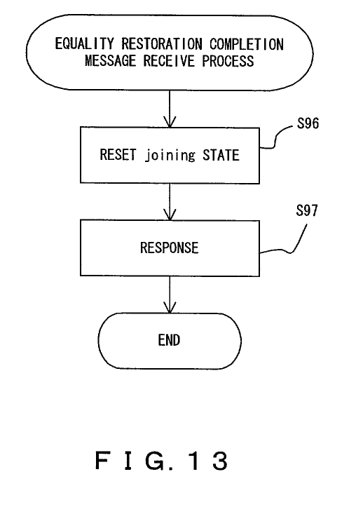

FIG. 13 is a flow chart showing the process of an active node that has received an equality restoration completion message from a node that has restored the data of a file of the node itself to the latest data by an equality restoration process.

When an active node receives an equality restoration completion message, the system structure managing portion 11 resets the joining state in the status of the internal control table corresponding to the requesting node (at step S96) and sends a response to the requesting node of the message (at step S97). Thereafter, the system structure managing portion 11 terminates the process.

By the process shown in FIG. 13, the active nodes of a system judge that the join process of a newly joined node in the system has been completed.

8) Join Retry Message

While a new node is being joined, when the system is restructured, a join retry message is sent to a node that is being joined to the system. When the system structure managing portion 11 receives a join retry message, the system structure managing portion 11 repeats the join process in the system from the beginning.

9) Stop Process

To stop the operation of a node, the operator inputs a leave command that causes the node to be broken away from the system. In this example, when a node is stopped, it is completely broken away from the system. When a node belongs to a plurality of systems, to completely stop the node for maintenance work or the like, leave commands should be input to those systems so that the node is broken away from all the systems.

When the operator inputs a leave command, the system structure managing portion 11 performs the following processes.

a) Systematic stop

A systematic stop is performed when all the nodes of a system are synchronously stopped and thereby the system is stopped. A systematic stop is performed for winter holidays, system restructuring or the like. To perform the systematic stop of the nodes, the operator inputs a leave command designated with an option “all”.

b) Non-systematic stop

A non-systematic stop is performed to stop only a node. Only a designated node is broken away from the system. At that point, other nodes operate the system. To perform the non-systematic stop of only a node, the operator inputs a leave command without an option “all”.

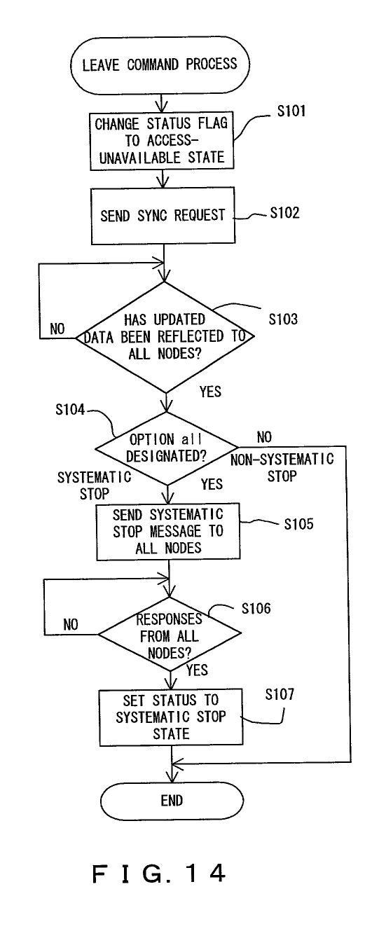

FIG. 14 is a flow chart showing the process of the system structure managing portion 11 in the case that the operator inputs a leave command to stop nodes.

When a leave command is input, the system structure managing portion 11 changes the state flag of the internal control table to an access-unavailable state at step S101. As a result, the other structural portion shown in FIG. 4 (namely, the IO request intercepting portion 12) is prohibited from accessing files that belong to a corresponding object group.

Thereafter, the system structure managing portion 11 sends a sync request to the changed data notifying portion 14 (at step S102) so as to ask it to reflect queued and delayed update requests on all nodes.

When the changed data notifying portion 14 has reflected changed data to all the nodes and notified the system structure managing portion 11 of the completion (namely, the judgment result at step S103 is Yes), if the leave command is not designated with an option “all” (namely, the judgment result at step S104 is No), since a non-systematic stop is performed, the system structure managing portion 11 terminates the process.

When a leave command is designated with an option “all” (namely, the judgment result at step S104 is Yes), since a systematic stop is performed, the system structure managing portion 11 sends systematic stop/start messages to all the nodes of the system for a predetermined time period (at step S105). Thereafter, the system structure managing portion 11 waits until it receives responses to the systematic stop start messages from all the nodes (at step S106). When the system structure managing portion 11 receives the responses from all the nodes (namely, the judgment result at step S106 is Yes), the system structure managing portion 11 sets the systematic stop flag of the system state table corresponding to the object group to a systematic stop state (at step S107) and then terminates the process.

10) Node Defect Recognition

In a group communications system where a message (“I'm alive” message) is usually sent from one node to another node, when the message is lost or a response is not returned, another node of the system recognizes such a situation. When a specific node recognizes that another node is broken away from the system, the node asks another active node of the system to restructure the system.

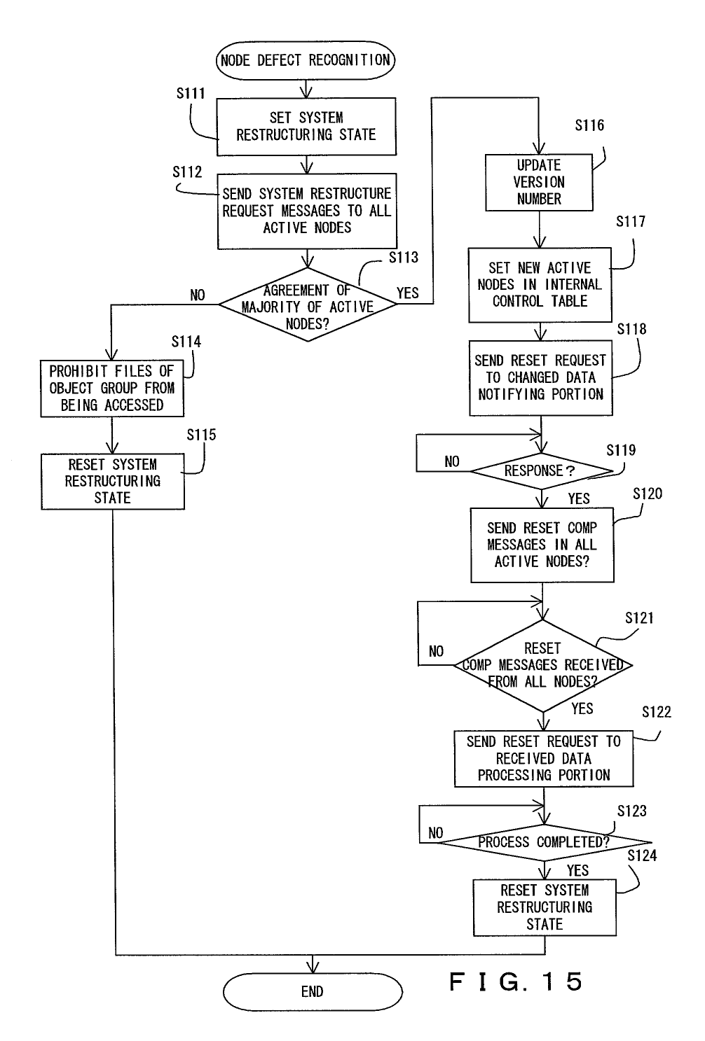

FIG. 15 is a flow chart showing the process of the system structure managing portion 11 that has recognized that another node had been broken away from the system.

When the system structure managing portion 11 recognizes a defect of a node of the system, the system structure managing portion 11 sets the state flag of the internal control table to a system restructuring state and temporarily stops the changed data notifying portion 14 from sending messages to other nodes.

Thereafter, the system structure managing portion 11 of the node itself sends system restructure request messages to the system structure managing portions 11 of all active nodes of the system so as to obtain the agreement of system restructure. When the system structure managing portion 11 of the node itself cannot obtain the agreement from the majority of the active nodes excluding a node that is being joined to the system (namely, the judgment result at step S113 is No), the system structure managing portion 11 of the node itself sets the state flag to an access-unavailable state (at step S114) so as to prohibit the files of the object group from being accessed. Then, the system structure managing portion 11 of the node itself resets the system restructuring state that has been set at step S111 (at step S115) and then terminates the process.

When the system structure managing portion 11 can obtain the agreement from the majority of active nodes (except for a node that is being joined) in response to the system restructure request (namely, the judgment result at step S113 is Yes), the system structure managing portion 11 of the node itself updates the system version number of the system state table (at step S116), changes the status of each node of the node defining portion, and sets the majority of nodes from which the agreement has been obtained as new active nodes in the internal control table (at step S117) so that the internal control table represents the latest system state.

Thereafter, the system structure managing portion 11 of the node itself sends a reset request to the changed data notifying portion 14 (at step S118) and waits for a response therefrom (at step S119). When the system structure managing portion 11 receives a response from the changed data notifying portion 14 (namely, the judgment result at step S119 is Yes), the system structure managing portion 11 of the node itself sends reset comp messages, which represent that a changed content queued in the update propagation transmission queue have been propagated to all nodes, to the system structure managing portions 11 of all active nodes and waits until reset comp messages are received from all the active nodes (at step S121).

When the system structure managing portion 11 has received the reset comp messages from all the nodes (namely, the judgment result at step S121 is Yes), since all propagated file update requests have been received by the node itself, the system structure managing portion 11 of the node itself sends a reset request to the received data processing portion 15 (at step S122) so as to ask it to perform discarding inconsistent update data where associated depend data has lost for the node that has been broken away from the system. Thereafter, the system structure managing portion 11 of the node itself waits for a process completion message (at step S123).

When the system structure managing portion 11 receives a process completion message from the received data processing portion 15 (namely, the judgment result at step S123 is Yes), the system structure managing portion 11 resets the system restructuring state that has been set at step S111 (at step S124), terminates the process, and then resumes a normal process.

The system structure managing portion 11 sends a join retry request to a node that is being joined to the system so as to retry a new join process to the system from the beginning.

[IO Request Intercepting Portion]

The IO request intercepting portion 12 receives a file access request from the user program 17 and sends an access request to the file system of the OS. When the user program 17 issues an input/output request for a file, the control is passed to the IO request intercepting portion 12.

When the file name of the requested file does not match any path of the internal control table, the IO request intercepting portion 12 immediately passes the control to the file system of the OS. The IO request intercepting portion 12 sends a response message of the file system to the user program 17.

When the file matches any path of the object group defining portion of the internal control table, the IO request intercepting portion 12 judges that the file corresponding to the access request belongs to the object group and performs the following processes.

1) In case the internal control table represents an access-unavailable state:

Since the object group is prohibited from being accessed, the IO request intercepting portion 12 sends an error response to the user program 17.

2) In case an equality restoration process is being performed:

The IO request intercepting portion 12 sends a read request or a write request designated with an option “force” to another active node so as to ask it to access the file. Since other nodes of the system (except for a node that is being joined to the system) have files containing the latest data, when an active node sends data to the IO request intercepting portion 12 in response to the read/write request, since the consistency of the data is assured, the IO request intercepting portion 12 sends the received data to the user program 17. When an active node sends an error message to the IO request intercepting portion 12 in response to the read/write request, it repeats the same process for other active nodes.

3) In case an equality restoring process is not being performed:

a) Write request

The IO request intercepting portion 12 asks the token managing portion 13 to acquire a write token for the requested file. When the token managing portion 13 sends a success message to the IO request intercepting portion 12, it calls the file system of the OS, performs the updating process of the data of the file of the node itself, and sends the changed content to the changed data notifying portion 14 so as to reflect the changed content on the other nodes.

When the token managing portion 13 sends a failure message to the IO request intercepting portion 12, the portion 12 sends a write request to a node that has a write token (the node is notified along with the message by the token managing portion 13) and asks it to perform the process. When the IO request intercepting portion 12 receives a process failure message (token change) from a node that has the write token in response to the write request, the IO request intercepting portion 12 repeats the token acquisition process from the beginning.

A wait process for updating the file of the node itself and a process for adding data to a write request sent to the received data processing portion 15 are performed by the IO request intercepting portion 12 as an order assurance process, which will be described later.

b) Read Request

The IO request intercepting portion 12 asks the token managing portion 13 to acquire a read token for a requested file. When the IO request intercepting portion 12 receives a success message from the token managing portion 13, the IO request intercepting portion 12 reads the data of the file of the node itself through the file system of the OS and sends the data to the user program 17.

When the IO request intercepting portion 12 receives a read token acquisition failure message from the token managing portion 13, the IO request intercepting portion 12 sends a read request to a node that has a write token (the node is notified along with the message by the token managing portion 13). When the IO request intercepting portion 12 receives a read success response from the requested node, the IO request intercepting portion 12 sends the received data to the user program 17. When the IO request intercepting portion 12 receives a read failure message (token change), the IO request intercepting portion 12 repeats the token acquisition process from the beginning.

An order assurance process, such as a wait process for waiting until preceding data is updated at other nodes will be described later.

In the example, a read/write token is acquired or released whenever the user program 17 issues a read/write request. Alternatively, to reduce the overhead of the system, a read/write token may be acquired/released whenever a file is opened or closed. In such a case, when the user program opens a file, the token process described above is performed. Until the file is closed, the token is stored. When the user program opens a file, if it is notified of a token acquisition failure message, a subsequent IO request is transferred to a node that has a token.

Alternatively, when a node that has a token completes a file process, it may not spontaneously release the token, but may represent that it does not need the token. Thus, the release of the token may be delayed until another node requires the token. When a file is written or read, another order assurance process, which will be described later, is performed.

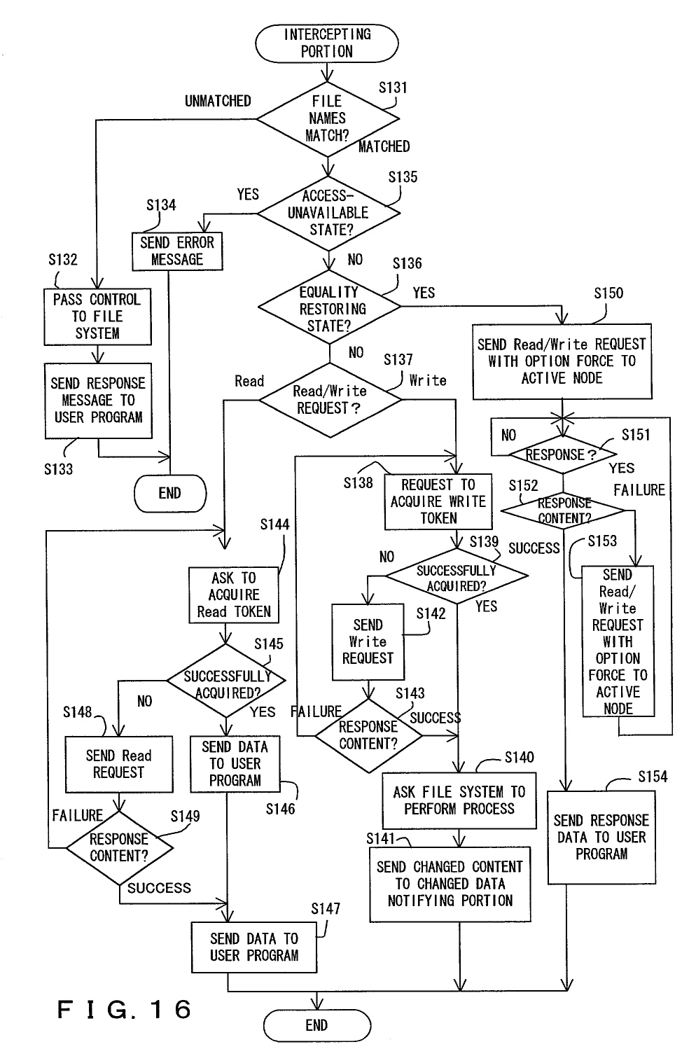

FIG. 16 is a flow chart showing the process of the IO request intercepting portion 12.

When the user program 17 issues a file access request, the IO request intercepting portion 12 references the internal control table and compares the file name of the requested file with the path name of the object group defining portion (at step S131). When they do not match (namely, the judgment result at step S131 is “unmatched”), since the requested file does not belong to the object group, the IO request intercepting portion 12 passes the control to the file system of the OS (at step S132) so as to ask it to process the file. The file system sends a response message to the user program (at step s133) and then terminates the process.

When the file name matches any path of the internal control table (namely, the judgment result at step S131 is “matched”), since in this case the file belongs to the object group, the IO request intercepting portion 12 detects the state flag of the internal control table. When the state flag represents an access-unavailable state (namely, the judgment result at step S135 is Yes), the IO request intercepting portion 12 sends an error response message to the user program 17 (at step S134). Thereafter, the IO request intercepting portion 12 terminates the process.

When the state flag represents an equality restoring state (namely, the judgment result at step S136 is Yes), the IO request intercepting portion 12 sends a read/write request designated with an option “force” to another active node (at step S150) and waits for a response message (at step S151). When the node sends a failure response message to the IO request intercepting portion 12 (namely, the judgment result at step S152 is “failure”), the IO request intercepting portion 12 sends a read/write request designated with an option “force” to another active node (at step S153) and waits for a response message. When the IO request intercepting portion 12 receives a success response from the active node (namely, the judgment result at step S152 is “success”), the IO request intercepting portion 12 sends response data to the user program 17 (at step S154) and then terminates the process.

When the state flag represents neither an access-unavailable state nor an equality restoring state (namely, the judgment results at steps S135 and S136 are No), the IO request intercepting portion 12 judges whether the access request is a read request. When the access request is a read request (namely, the judgment result at step S137 is “read”), the IO request intercepting portion 12 asks the token managing portion 13 to acquire a read token for the required file (at step S144).

When the IO request intercepting portion 12 receives a token acquisition success message from the token managing portion 13 (namely, the judgment result at step S145 is Yes), the IO request intercepting portion 12 reads data from the corresponding file of the node itself through the OS file system (at step S146). Thereafter, the IO request intercepting portion 12 sends the data to the user program (at step S147). In the structure where an acquired token is spontaneously released, the IO request intercepting portion 12 asks the token managing portion 13 to release the token and then terminates the process. When the IO request intercepting portion 12 receives a read token acquisition failure message from the token managing portion 13 (namely, the judgment result at step S145 is No), the IO request intercepting portion 12 sends a read request to a node that has a token and is notified, along with the failure message (at step S148) and waits for a response message. When the IO request intercepting portion 12 receives a success message from a node that has a write token (namely, the judgment result at step S149 is “success”), the IO request intercepting portion 12 sends the passed data to the user program 17 (at step S147) and then terminates the process. When a node that has a write token sends a failure message to the IO request intercepting portion 12 (namely, the judgment result at step S149 is “failure”), the IO request intercepting portion 12 repeats the read token acquisition process from the beginning (at step S144). When the propagating mode of the relevant file at step S146 is an asynchronous mode or a semi-synchronous mode, the IO request intercepting portion 12 references the real state reflection delay queue. When the real state reflection delay queue contains the latest data, the IO request intercepting portion 12 reads the data from the queue. This operation will be described in detail in the section of “Order Assurance”.

When the access request at step S137 is a write request (namely, the judgment result at step S137 is “write”), the IO request intercepting portion 12 asks the token managing portion 13 to acquire a write token for the requested file.

As a result, when the IO request intercepting portion 12 receives a token acquisition success message from the token managing portion 13 (namely, the judgment result at step S139 is Yes), the IO request intercepting portion 12 calls the OS file system and asks it to perform a write process for the file of the node itself (at step S140). The IO request intercepting portion 12 sends the changed content to the changed data notifying portion 14 so as to ask it to reflect the changed data on other nodes (at step S141). In a structure where a token is spontaneously released, the IO request intercepting portion 12 asks the token managing portion 13 to release the token and then terminates the process. When the IO request intercepting portion 12 receives a token acquisition failure message from the token managing portion 13 (namely, the judgment result at step S139 is No), the IO request intercepting portion 12 sends a write request to a node that has a write token (at step S142) and then waits for a response message. When the IO request intercepting portion 12 receives a failure response message from the node that has the write token (namely, the judgment result at step S143 is “failure”), the IO request intercepting portion 12 repeats the write token acquisition process (at step S138). When the IO request intercepting portion 12 receives a success message from the node that has the write token (namely, the judgment result at step S143 is “success”), the IO request intercepting portion 12 terminates the process in consideration of the reflection of the updated content on the file of the node itself by the order assurance process, which will be described later. When the IO request intercepting portion 12 asks the file system to perform a process (at step S140), in case the propagation mode of the corresponding file is an asynchronous mode or a semi-synchronous mode, the IO request intercepting portion 12 queues the changed content in the real state reflection delay queue and performs a process in consideration of the order assurance. This operation will be described in detail in the section of “Order Assurance”.

[Token Managing Portion]

The token managing portion 13 manages a file access right in such a manner that all the nodes of a system have the same information. To simply the structure of the system, one of the nodes is usually designated as a token managing node (for example, a node having the smallest network address). The token managing portion 13 of the token managing node is designated as a server. The server stores and manages all token states of the system. The token managing portion 13 of each of the other nodes is designated as a client that manages only a token that the node has.

The token managing portion 13 of the token managing node stores a token control table in the memory. Using the token control table, the token managing portion 13 manages all the nodes of the system.

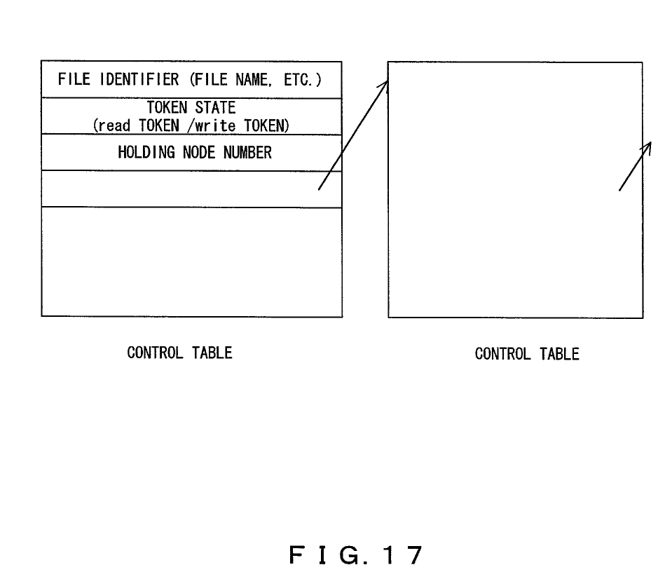

FIG. 17 is a schematic diagram showing an example of the structure of the token control table.

The token control table shown in FIG. 17 has a list data structure. One token control table is created for each file of the object group. Each token control table contains a file identifier, a token state, a storing node number, and a pointer. The file identifier identifies a token for the file of the object group. The token state represents the type of a token (read token or write token) The storing node number represents a node that has a token. The pointer represents one of the next control tables. The file identifier is a tag with which the token managing portion 13 retrieves data from a corresponding control table. For the file identifier, for example, the file name of a corresponding file is used. To quickly retrieve data from a list, a hash function is applied to the file identifier. A queue is structured with file identifiers having the same hash values.

When the token managing portion 13 of the token managing node receives a token process request from the IO request intercepting portion 12 of the node itself or the token managing portion 13 of another node, the token managing portion 13 of the node itself retrieves the token state of the required file from the token control table. When the token managing portion 13 creates or releases a token, the token managing portion 13 adds a new token control table to the list data or deletes a corresponding token control table from the list data.

When the system is restructured, the token states of the entire system are restored based on the latest token storage information of each node.

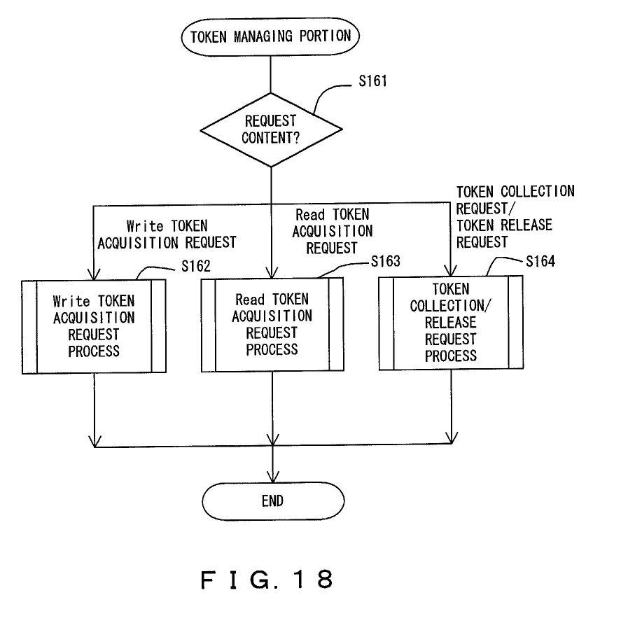

FIG. 18 is a flow chart showing the process of the token managing portion 13 of the token managing node.

When the token managing portion 13 of the node itself receives a token process request from the token managing portion 13 of another node or the IO request intercepting portion 12 of the node itself, the token managing portion 13 of the node itself performs the following process.

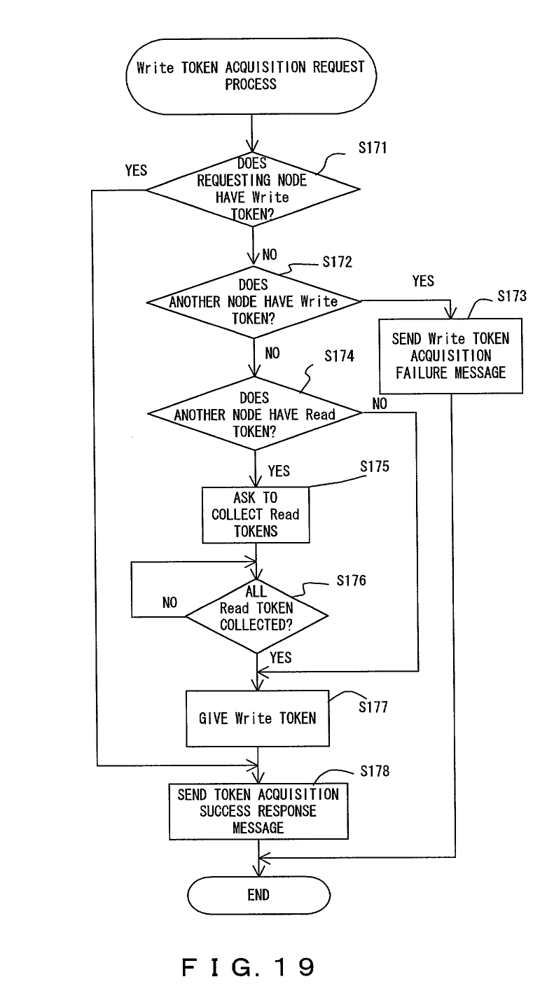

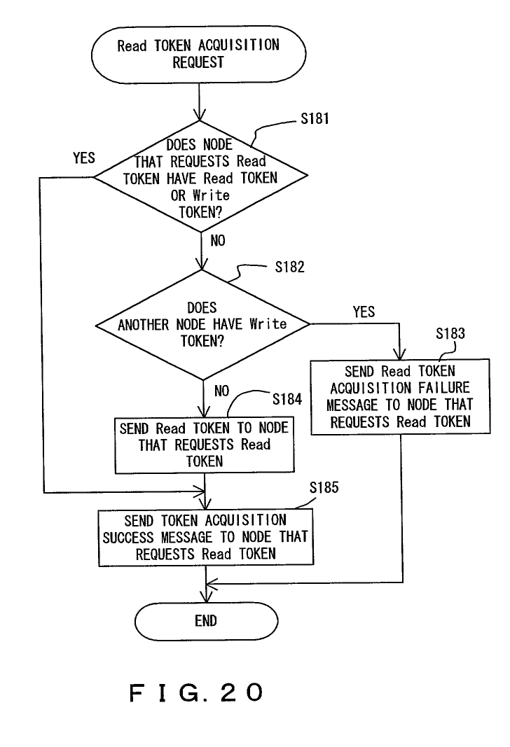

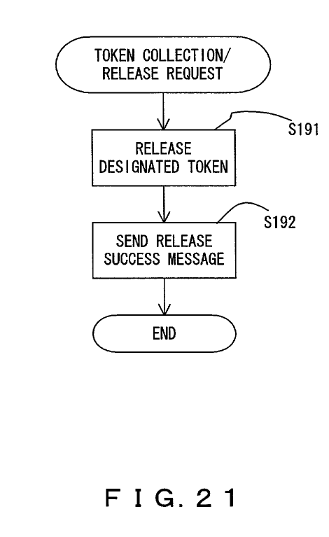

When the token managing portion 13 of the node itself receives a process request from the token managing portion 13 of another node or the IO request intercepting portion 12 of the node itself, the token managing portion 13 of the node itself detects the request content (at step S161). When the process request is a write token acquisition request, the token managing portion 13 of the node itself performs a write token acquisition request process (at step S162 shown in FIG. 19). When the process request is a read token acquisition request, the token managing portion 13 of the node itself performs a read token acquisition request process (at step S163 shown in FIG. 20). When the process request is a token release request or a token collection request, the token managing portion 13 of the node itself performs a token release/collection request process (at step S164 shown in FIG. 21). Thereafter, the token managing portion 13 of the node itself terminates the process.

FIG. 19 is a flow chart showing the write token acquisition request process of the token managing portion 13 at step S162 shown in FIG. 18.

In the write token acquisition process, the token managing portion 13 references a token control table and judges whether a node that has issued a write token acquisition request has a write token (at step S171). When the node has a write token (namely, the judgment result at step S171 is Yes), the token managing portion 13 sends a token acquisition success message to a node that requests a write token (at step S178) and terminates the process. When the node that requests a write token does not have a write token (namely, the judgment result at step S172 is No), the token managing portion 13 judges whether another node has a write token for a required file. When another node has a write token (namely, the judgment result at step S172 is Yes), the token managing portion 13 sends a write token acquisition failure message to the node that requests a write token along with the node number of a node that has a write token (at step S173) and then terminates the process.

When no node has a write token (namely, the judgment result at step S172 is No), the token managing portion 13 judges whether another node has a read token for the requested file (namely, the judgment result at step S174 is No). When no node has a read token (namely, the judgment result at step S174 is No), the token managing portion 13 modifies the token control table, giving a write token to the node that requests a write token (at step S178), sends a token acquisition success message to the requesting node, and terminates the process. When there is a node that has a read token (namely, the judgment result at step S175 is Yes), the token managing portion 13 asks all nodes that have read tokens to collect the read tokens and waits until the token managing portion 13 receives token collection completion messages from the nodes that have read tokens (namely, the judgment result at step S176 is No). After all the nodes that have read tokens collects the read tokens (namely, the judgment result at step S176 is Yes), the token managing portion 13 gives a write token to the node that requests the write token (at step S177), sends a token acquisition success message to the node that requests the write token (at step S178), and then terminates the process.

FIG. 20 is a flow chart showing the read token acquisition request process of the token managing portion 13 at step S163 shown in FIG. 18.

In the read token acquisition request process, the token managing portion 13 references the token control table and judges whether a node that issues a read token acquisition request has a read token or a write token (at step S181). When the requesting node has either a read token or a write token (namely, the judgment result at step S181 is Yes), the token managing portion 13 sends a token acquisition success message to the node that requests a read token (at step S185) and then terminates the process. When the node that issues a read node acquisition request has neither a read token nor a write token (namely, the judgment result at step S181 is No), the token managing portion 13 judges whether another node has a write token for the requested file. When the node has a write token (namely, the judgment result at step S182 is Yes), the token managing portion 13 sends a read token acquisition failure message along with the node number of the node that has a write token to the node that requests a read token (at step S183) and then terminates the process.

When no node has a write token (namely, the judgment result at step S182 is No), the token managing portion 13 modifies the token control table so that a read token is given to the node that requests a read token (at step S173). Thereafter, the token managing portion 13 sends a token acquisition success message to the node that requests a read token (at step S184) and then terminates the process.

FIG. 21 is a flow chart showing the token release/collection request process of the token managing portion 13 at step S164 shown in FIG. 18.

A node that does not need a token issues a token release request. A token release request is issued after updated data has been propagated to all nodes of the system. In the structure where an unnecessary token is not spontaneously released, when a node that has a token receives a token release request, the token managing portion 13 represents a token release state. In the write token acquisition request process and the read token acquisition request process, the token managing portion 13 asks a node that has a write token to collect the token. When the token managing portion 13 receives a token collection completion message from the node that has a token, the token managing portion 13 performs a process assuming that it has acquired the token. When the token managing portion 13 receives a token collection failure message, it performs a process assuming that there is a node that has the token.

A token collection request is a request that the token managing portion 13 of the token managing node issues to a node that has a read/write token in the write token acquisition request process. A write token collection request is issued only in the structure where a node that has a token does not spontaneously release an unnecessary token.

When the token managing portion 13 receives a token release request or a token collection request, the token managing portion 13 immediately releases a designated token (at step S191) and sends a release success message to the token managing portion 13 of the token managing node (at step S192) and then terminates the process.

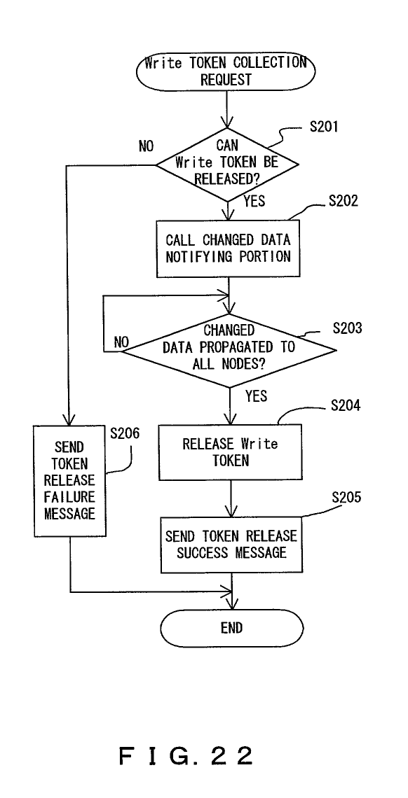

FIG. 22 is a flow chart showing the process of the token managing portion 13 of a node that has a token and receives a write token collection request that is issued in case an unnecessary token is not spontaneously released.

When the token managing portion 13 receives a write token collection request, the token managing portion 13 judges whether it can release a write token (at step S201). When the node has not completely written updated data into the corresponding file, since the node cannot release the write token (namely, the judgment result at step S201 is No), the node sends a token release failure message to the token managing portion 13 of the token managing node that has sent the write token collection request (at step S206) and then terminates the process.

When the node can release a write token (namely, the judgment result at step S201 is Yes), the token managing portion 13 calls the changed data notifying portion 14 designated with an option “FSYNC” (at step S202) and asks the changed data notifying portion 14 to propagate the changes of files performed by the node itself and the changed contents of the files requested by other nodes to all the nodes of the system and waits for completion messages therefrom (namely, the judgment result at step S203 is No).

When the changed data notifying portion 14 receives completion messages from all the nodes and sends a propagation completion message to the token managing portion 13 (namely, the judgment result at step S203 is Yes), the token managing portion 13 releases the write token (at step S204), sends a token release success message to the token managing portion 13 of the token managing node (at step S205), and then terminates the process.

[Changed Data Notifying Portion]

The changed data notifying portion 14 receives the updated data of a file from the IO request intercepting portion 12 or the received data processing portion 15 and schedules the reflection of the changed content of the file on other nodes.

The changed data notifying portion 14 performs the following process in a propagation mode (synchronous mode, asynchronous mode, or semi-synchronous mode) represented in a system state table corresponding to the designated file.

A user selects one of the synchronous mode, semi-synchronous mode, and asynchronous mode based on the reliability requirement for each object group. These modes have the following characteristics.

Synchronous mode: When the user program 17 receives a write completion message in response to a file write request, it is assured that the updated data of the file has been propagated to all the nodes. Thus, unless all the nodes are destroyed, the data is not lost.

Semi-synchronous mode: When the user program 17 receives a write completion message in response to a file write request, it is assured that the updated result has been propagated to the majority of the nodes. Thus, unless more than half of all the nodes are destroyed at the same time, the data is not lost. In other words, when the system is degenerated due to a defect of a node, since a new system is created by more than half of nodes of the system, the data is not lost.

Asynchronous mode: When the user program 17 receives a write completion message in response to a file write request, it is not assured that the updated result has been propagated to other nodes. Thus, when a defect takes place in a node, the updated result may be lost. However, in the system according to the embodiment, the order of the updated result is assured. Thus, old data and new data do not coexist.

1) Process in the case of propagation in a synchronous mode

A changed content is transferred to all the active nodes of an object group. After completion messages are received from all the nodes, the control is returned to the requesting node.

2) Process in the case of propagation in a semi-synchronous mode

A changed content is transferred to all the active nodes of an object group. After completion messages are received from the majority of nodes, the control is returned to the requesting portion. However, until the changed content is propagated to all the nodes, a write token is not released.

3) Process in the case of propagation in an asynchronous mode

A changed content is queued to a memory for each target node. At proper timings, the changed content is transferred.

The proper timings are as follows:

1) When the changed data notifying portion 14 receives a sync request from the system structure managing portion 11, the changed data notifying portion 14 propagates all the updated data to all the nodes.

2) Before a write token is released from the token managing portion 13, when the changed data notifying portion 14 is called designated with an option “fsync”, the changed content of a target file is propagated to all the nodes.

3) At a proper timing designated by the system (for example, when a predetermined time period elapses or a predetermined amount of data is queued), all the updated data is propagated to all the nodes.

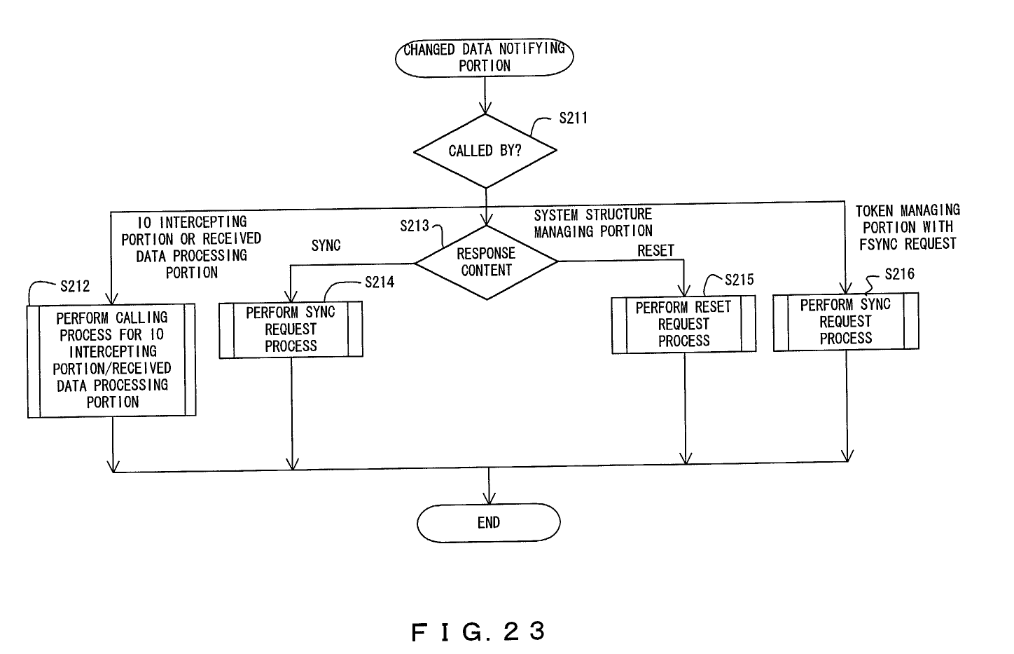

FIG. 23 is a flow chart showing the process of the changed data notifying portion 14.

When the changed data notifying portion 14 is called by another structural portion, the changed data notifying portion 14 identifies the calling portion (at step S211) As a result, when the changed data notifying portion 14 is called by the IO request intercepting portion 12 or the received data processing portion 15, the changed data notifying portion 14 performs the process of calling the IO request intercepting portion/received data processing portion. When the changed data notifying portion 14 is called by the system structure managing portion 11 and the requested content is a sync request (namely, the judgment result at step S213 is “sync”), the changed data notifying portion 14 performs a sync request process (at step S214). If the requested content is a reset request, the changed data notifying portion 14 performs a reset request process (at step S215). When the changed data notifying portion 14 is called by the token managing portion 13 as a fsync request, the changed data notifying portion 14 performs a fsync request process (at step S216). After the changed data notifying portion 14 performs the corresponding process, it terminates the process shown in FIG. 23.

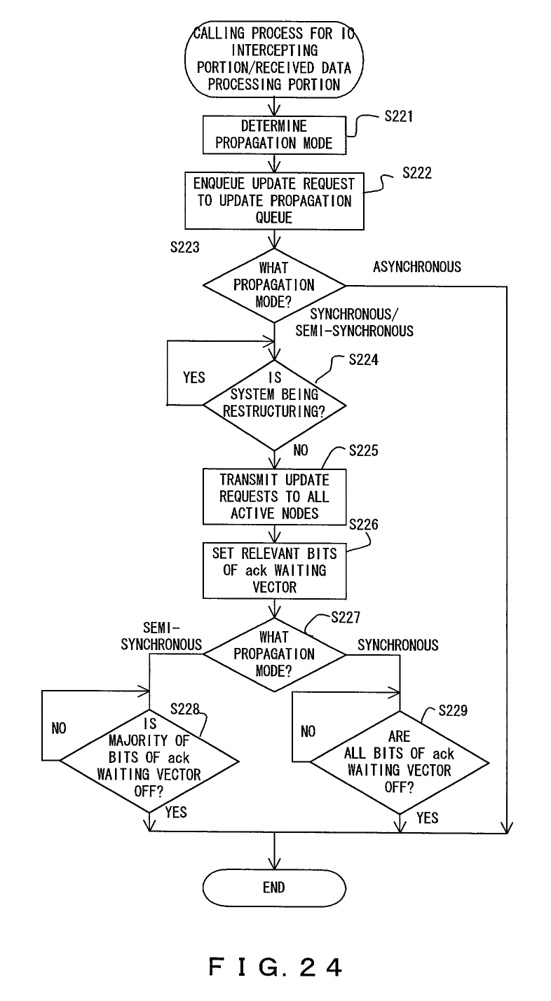

FIG. 24 is a flow chart showing the calling process of the IO request intercepting portion/received data processing portion at step S212 shown in FIG. 23.

In the calling process of the IO request intercepting portion/received data processing portion, the changed data notifying portion 14 determines the propagation mode in the internal control table of an object group corresponding to the object group number of a update request received from the called portion (at step S221). Thereafter, the changed data notifying portion 14 queues the update request at the end of the update propagation queue (at step S222). When the propagation mode found at step S211 is an asynchronous mode (namely, the judgment result at step S223 is “asynchronous”), the changed data notifying portion 14 terminates the process. Thereafter, the control is returned to the called portion.

When the propagation mode is a synchronous mode or a semi-synchronous mode (namely, the judgment result at step S223 is “synchronous/asynchronous”), if the state flag of the internal control table represents a system restructuring state, the changed data notifying portion 14 waits until the system is restructured and the state flag does not represent the system restructuring state (at step S224). Thereafter, the changed data notifying portion 14 sends update requests to all the active nodes of the system (at step S225).

After the changed data notifying portion 14 sends the update requests, the changed data notifying portion 14 sets the bits of the ack waiting vector of the update propagation transmission queue corresponding to the nodes to which the update requests have been sent (at step S226) and waits for response messages therefrom. When the propagation mode is a semi-synchronous mode (namely, the judgment result at step S227 is “semi-synchronous”), the changed data notifying portion 14 waits until it receives reception completion messages from the majority of the received data processing portions 15 of the nodes to which the update request have been sent (at step S228) and then terminates the process. Thereafter, the control is returned to the called portion.

When the propagation mode is a synchronous mode (namely, the judgment result at step S227 is “synchronous”), the changed data notifying portion 14 waits until all the bits of the ack wait vector are set off (at step S229). In the structure where an unnecessary token is spontaneously released, the changed data notifying portion 14 releases a token and then terminates the process. Thereafter, the control is returned to the called portion.

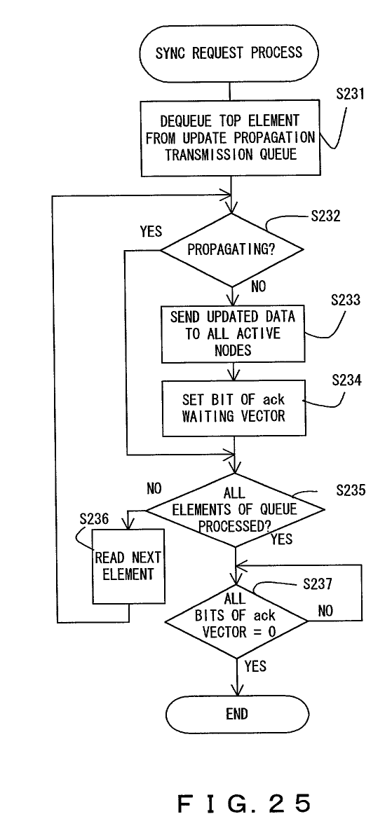

FIG. 25 is a flow chart showing the sync request process of the changed data notifying portion 14 at step S214 shown in FIG. 23. In the sync request process, the changed data notifying portion 14 propagates change requests queued in the update propagation transmission queue to all the nodes of the system and dequeues the update requests therefrom. A sync request process is performed when the system structure managing portion 11 having a sync request calls the changed data notifying portion 14.

In the sync request process, the changed data notifying portion 14 dequeues the top element from the update propagation transmission queue using the entry of the update propagation transmission queue of the internal control table (at step S231).

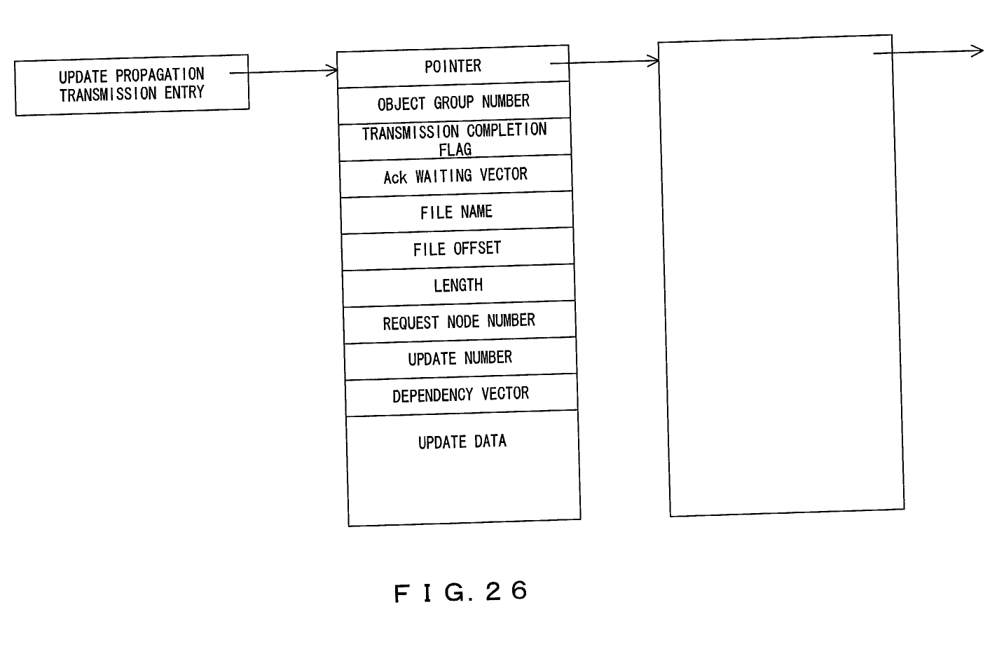

FIG. 26 is a schematic diagram showing an example of the structure of the update propagation transmission queue.

The update propagation transmission queue is a buffer that queues an update request. An update propagation transmission queue entry represents the position of the top element of a list structure. One element of the list structure corresponds to one update request. When an update request takes place, the changed data notifying portion 14 enqueues a new element to the end of the update propagation transmission queue. When the changed data notifying portion 14 completes the process, it deletes the relevant element.

Each element of the list data contains a pointer, an object group number, a transmission completion flag, an ack waiting vector, a file name, an offset, a length, a request node number, an update number, a dependency vector, and updated data. The pointer represents the position of the next element. The object group number represents an object group that a file that is updated belongs to. The transmission completion flag represents whether or not the update request has been sent to another node. The ack waiting vector represents the response state of each node. The file name represents the name of a file that is updated. The offset represents the update position of the file. The length represents the size of updated data. The requesting node number represents the node number of a node that issues an update request. The updated data represents an updated content. Among them, the update number and the dependency vector are used for the order assurance process that will be described in detail later in the section of “Order Assurance”.

When the transmission completion flag that has been read at step S231 represents a non-transmission state (namely, the judgment result at step S232 is No), the changed data notifying portion 14 sends the update requests for the element to all the active nodes of the system (at step S233) and sets the bits of the ack vector corresponding to the nodes to which the update requests have been sent (at step S234). When the transmission completion flag represents a transmission completion state, if the transmission request is being propagated to another node (namely, the judgment result at step S232 is Yes), the changed data notifying portion 14 skips the element.

Thereafter, the changed data notifying portion 14 dequeues the next element from the update propagation transmission queue (namely, the judgment result at step S235 is No; and at step S236). Thereafter, the changed data notifying portion 14 repeats the loop of steps S232 to S234.

When the changed data notifying portion 14 has performed the process for all the elements of the queue (namely, the judgment result at step S235 is Yes), the changed data notifying portion 14 waits until all the bits of the ack waiting vector corresponding to all the elements of the update propagation transmission queue becomes 0, that is, waits until it receives reception completion messages from all the nodes to which the update requests have been sent (at step S237). Thereafter, the changed data notifying portion 14 terminates the process and returns the control to the called portion.

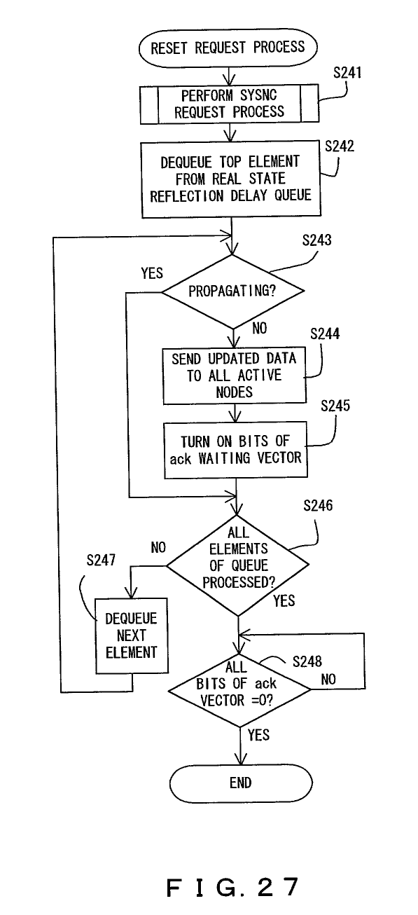

FIG. 27 is a flowchart showing the reset request process of the changed data notifying portion 14 at step S215 shown in FIG. 23. A reset request process is performed for all nodes to propagate requests that have been suspended due to the occurrence of a defect and to synchronize all nodes of a new system. A reset request process is performed for the system structure managing portion 11 that has recognized the defect of another node, by the changed data notifying portion 14 called by a reset request. In the reset request process, all update requests queued in the update propagation transmission queue and the real state reflection delay queue are propagated to other nodes so as to reflect updated contents on the other nodes.

In the reset request process, the changed data notifying portion 14 performs a sync request process that is the same as that shown in FIG. 26 so as to propagate change requests queued in the update propagation transmission queue to other nodes of the system and notify them of the changed contents (at step S241).

The changed data notifying portion 14 dequeues the top element from the real state reflection delay queue by judging the position from the entry of the real state reflection delay queue of the internal control table and (at step S242).

When the transmission completion flag that has been read at step S242 represents a non transmission state (namely, the judgment result at step S243 is No), the changed data notifying portion 14 sends the update request of the element to all the active nodes of the system (at step S244). Thereafter, the changed data notifying portion 14 sets the bits of the ack vectors corresponding to the nodes to which the update requests have been sent (at step S245). When the transmission completion flag of the element represents a transmission completion state and the transmission request is being propagated to another node (namely, the judgment result at step S243 is Yes), the changed data notifying portion 14 skips steps 244 and 245 for the element.

Thereafter, the changed data notifying portion 14 dequeues the next element from the real state reflection delay queue (namely, the judgment result at step S246 is No; at step S247) Thereafter, the changed data notifying portion 14 repeats the loop of step S243 to step S245.

When the changed data notifying portion 14 has completed the process for all the elements of the queue (namely, the judgment result at step S246 is Yes), the changed data notifying portion 14 waits until all the bits of the ack waiting vectors of the elements of the real state reflection delay queue becomes 0, that is, the changed data notifying portion 14 waits until it receives reception completion messages from all the nodes to which the update requests have been sent (at step S248), terminates the process, and returns the control to the called portion.

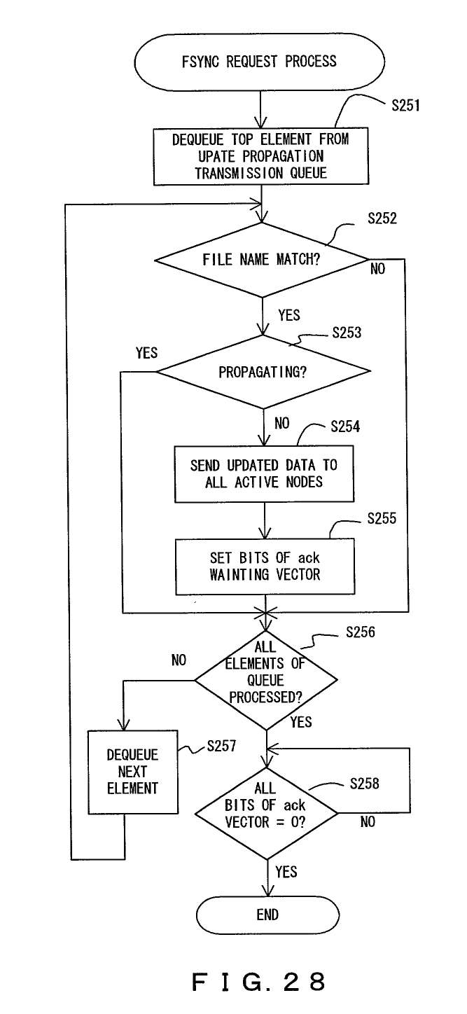

FIG. 28 is a flow chart showing the fsync request process of the changed data notifying portion 14 at step S216 shown in FIG. 23. In the fsync request process, the system structure managing portion 11 issues a fsync request by designating a file name and the changed data notifying portion 14 performs a fsync request process. The changed data notifying portion 14 propagates all change requests queued in the update propagation transmission queue for a designated file to other nodes of the system and dequeues the change requests therefrom.

In the fsync request process, the changed data notifying portion 14 dequeues the top element from the update propagation transmission queue using the entry of the update propagation transmission queue of the internal control table (at step S251).

When the file name of the element that has been dequeued at step S251 matches the designated file name (namely, the judgment result at step S252 is Yes) and the transmission completion flag represents a non transmission state (namely, the judgment result at step S253 is No), the changed data notifying portion 14 transmits update requests for the element to all active nodes (at step S254) and sets the bits of the ack vector corresponding to the nodes to which the update requests have been sent (at step S255). When the file name of the element does not match the designated file name (namely, the judgment result at step S252 is No) or even if they match, when the transmission completion flag of the element represents a transmission completion state and the transmission request is being propagated to another node (namely, the judgment result at step S253 is Yes), the changed data notifying portion 14 skips the element.

Thereafter, the changed data notifying portion 14 dequeues the next element from the update propagation transmission queue (namely, the judgment result at step S256 is No; at step S257). Thereafter, the changed data notifying portion 14 repeats the loop of steps 252 to 255.

When the changed data notifying portion 14 has completed the process for all the elements of the queue (namely, the judgment result at step S256 is Yes), the changed data notifying portion 14 waits until the changed data notifying portion 14 receives reception completion messages from all the nodes to which the update requests have been sent (at step S258), terminates the process, and returns the control to the called portion.

Thereafter, the changed data notifying portion 14 scans the real state reflection delay queue from the beginning at a proper timing and transfers a predetermined number of change requests that have not been propagated to all active nodes.

[Received Data Processing Portion]

The received data processing portion 15 receives data from another node and reflects the data to the node itself.

The received data processing portion 15 receives four types of data that are an update request, a read/write request, a reset request, and equality restoration transfer data, from other nodes, and performs corresponding processes.

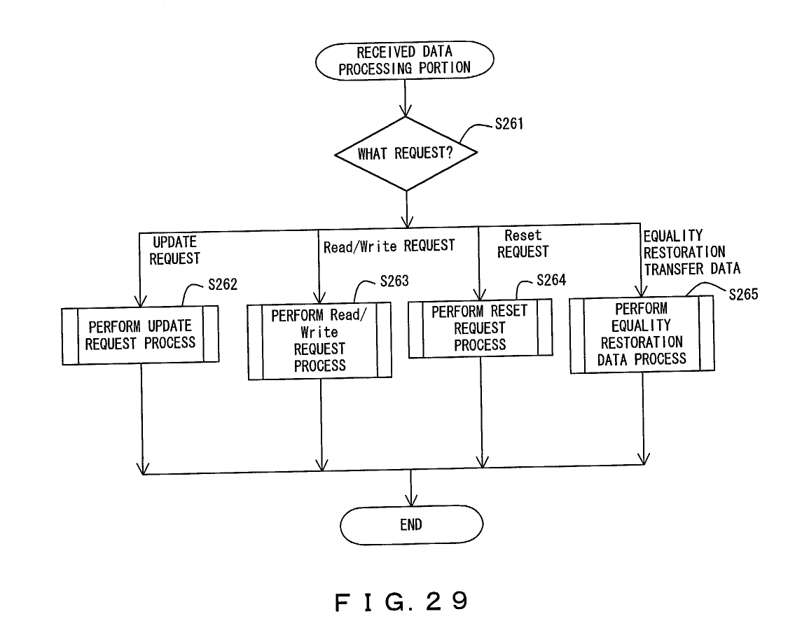

FIG. 29 is a flow chart showing the process of the received data processing portion 15.

When the received data processing portion 15 receives a request from another node, the received data processing portion 15 detects the content thereof (at step S261). When the request is an update request, the received data processing portion 15 performs an update request process (at step S262). When the node itself has a write token and receives a read request or a write request from another node, the received data processing portion 15 performs a read/write request process (at step S263). When another node detects a node that has been broken away from the system and sends a reset request to the node, the received data processing portion 15 performs a reset request process (at step S264). When the node itself receives equality restoration transfer data from another node to which the node itself has sent an equality restoration transfer request while performing an equality restoration process, the received data processing portion 15 performs an equality restoration transfer data process (at step S265).

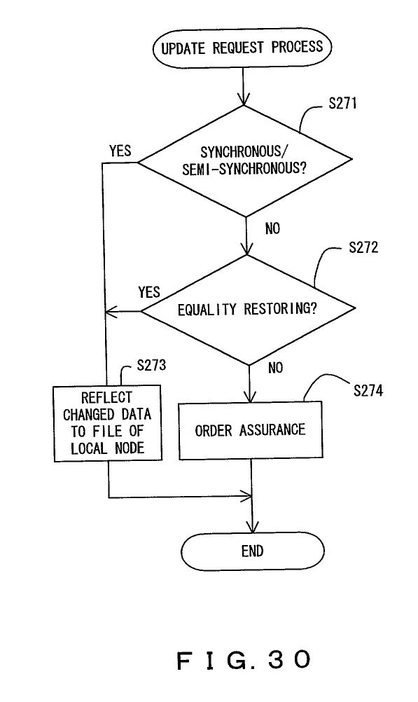

FIG. 30 is a flowchart showing the update request process of the received data processing portion 15 at step S262 shown in FIG. 29.

In the update request process, the received data processing portion 15 references the internal control table of an object group corresponding to received updated data, detects the propagation mode of the object group and judges whether the state flag represents an equality restoring state. When the propagation mode is a synchronous mode or a semi-synchronous mode (namely, the judgment result at step S271 is Yes) or even if the propagation mode is an asynchronous mode, when the state flag represents an equality restoring state (namely, the judgment result at step S271 is No and the judgment result at step S272 is Yes), the received data processing portion 15 immediately reflects the changed data on the corresponding file of the node itself through the OS file system (at step S273) and then terminates the process.

When the transmission mode is an asynchronous mode (namely, the judgment result at step S271 is No) and the state flag does not represent an equality restoring state (namely, the judgment result at step S272 is No), the received data processing portion 15 queues a received change request to the end of the real state reflection delay queue (at step S274) and reflects the change request on the file of the node itself in consideration of order assurance. Order assurance will be described later in detail.

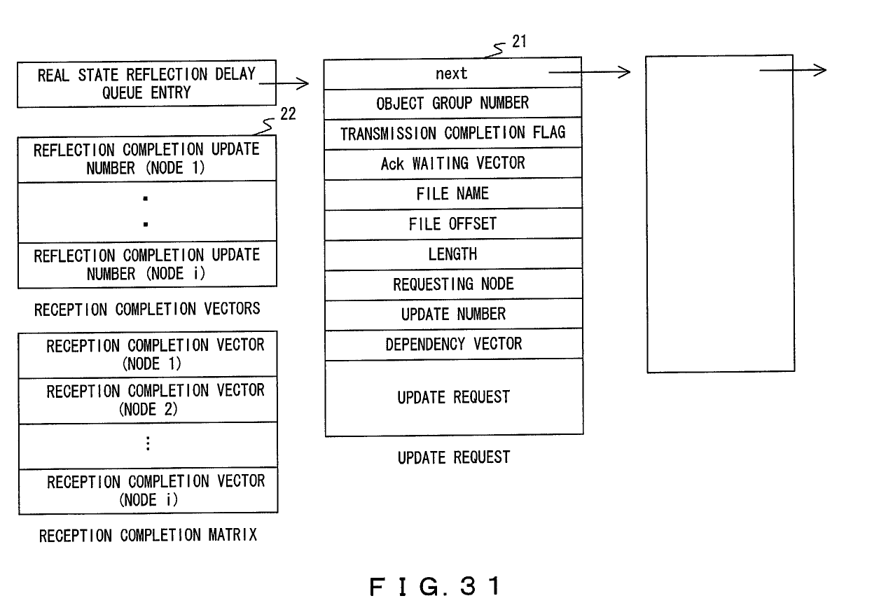

FIG. 31 is a schematic diagram showing an example of the structure of the real state reflection delay queue.

A real state reflection delay queue is a buffer that queues an update request in an asynchronous mode. The real state reflection delay queue is composed of a queue portion 21 and a reception completion vector 22 that have a array structure where the position of the top element is represented by the real state reflection delay queue entry of the internal control table. One element of the queue portion 21 corresponds to one update request. When the received data processing portion 15 receives an update request for a file of the object group in an asynchronous mode, the received data processing portion 15 queues the received update request to the end of the real state reflection delay queue. After the received data processing portion 15 completes the process, it deletes a corresponding element from the real state reflection delay queue.

The structure of each element of the queue portion 21 is basically the same as the structure of each element of the update propagation transmission queue. In other words, each element of the queue portion 21 contains a pointer, an object group name, a transmission completion flag, an ack waiting vector, a file name, an offset, a length, a requesting node number, an update number, a dependency vector, and updated data. The pointer represents the position of the next element. The object group number represents an object group to which a file that is updated belongs. The transmission completion flag represents whether or not the update request has been transmitted to another node. The ack waiting vector represents a response state for each node. The file name represents the file name of a file that is updated. The offset represents the update position of a file. The length represents the size of updated data. The requesting node number represents the node number of a node that issues an update request. The updated data represents an updated content.

Among them, the update number and the dependency vector are used in the order assurance process that will be described in detail later in the section of “Order Assurance”. The transmission completion flag and the ack waiting vector are used only when the received data processing portion 15 receives a reset request from the system structure managing portion 11.

The reception completion vector 22 comprises elements for the nodes of a system and records the latest dependency vector in the received update request. This operation will be also described in detail later in the section of “Order Assurance”.

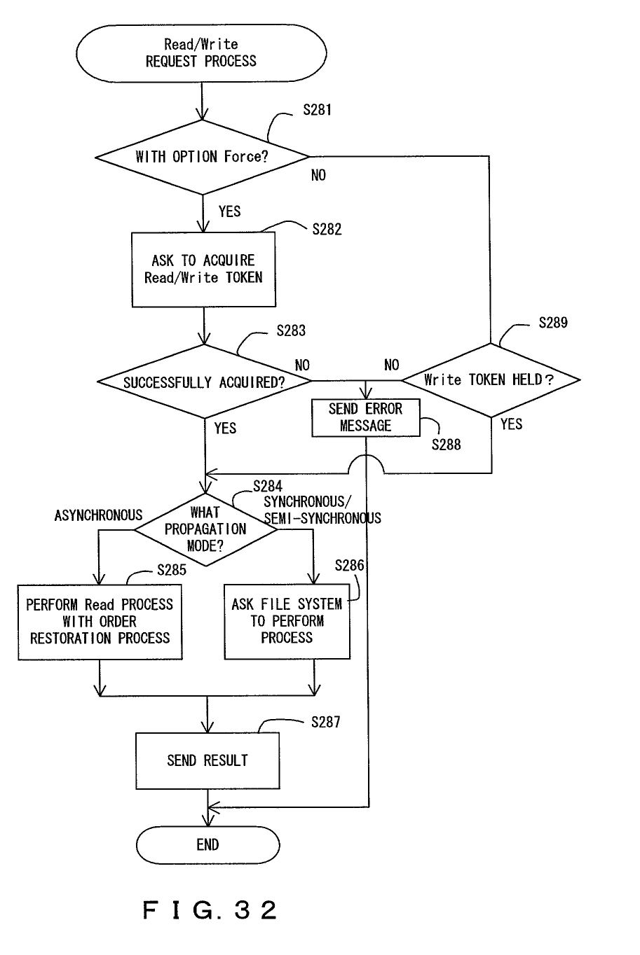

FIG. 32 is a flowchart showing the read/write request process of the received data processing portion 15 at step S263 shown in FIG. 29.

In the read/write request process, the received data processing portion 15 performs a process that varies depending on whether or not the received read/write request is designated with an option “force”.

When the received data processing portion 15 receives a read/write request from a node that is performing an equality restoration process and the read/write request is designated with an option “force” (namely, the judgment result at step S281 is Yes), the received data processing portion 15 asks the token managing portion 13 to acquire a read token or a write token necessary for performing the request process (at step S282). When the token managing portion 13 successfully acquires the token (namely, the judgment result at step S283 is Yes), the flow advances to step S284. When the token managing portion 13 does not acquire the token (namely, the judgment result at step S283 is No), the received data processing portion 15 sends an error message to the requesting node as a response message and then terminates the process.

When the received read/write request is not designated with an option “force” (namely, the judgment result at step S281 is No), if the node itself does not have a write token (namely, the judgment result at step S289 is No), the received data processing portion 15 sends an error message to the requesting node as a response message and then terminates the process. When the node itself has a write token (namely, the judgment result at step S289 is Yes), the flow advances to step S284.

The received data processing portion 15 references the internal control table and detects the propagation mode of an object group corresponding to the read/write request (at step S284). When the propagation mode is a synchronous mode or a semi-synchronous mode (namely, the judgment result at step S284 is “synchronous/asynchronous”), the received data processing portion 15 asks the OS file system to perform a requested process (at step S286), sends the result to the requesting node and then terminates the process. When the requested process is a write process (at step S286), the received data processing portion 15 performs the write process for the file of the node itself and asks the changed data notifying portion 14 to propagate the changed content to other nodes.

When the propagation mode of an object group corresponding to the read/write request is an asynchronous mode (namely, the judgment result at step S284 is “asynchronous”), the received data processing portion 15 performs a process similar to the read/write request process of the IO request intercepting portion 12 in consideration of the order assurance process which will be described later in the section of “Order Assurance”, sends the result to the requesting node (at step S287) and then terminates the process.

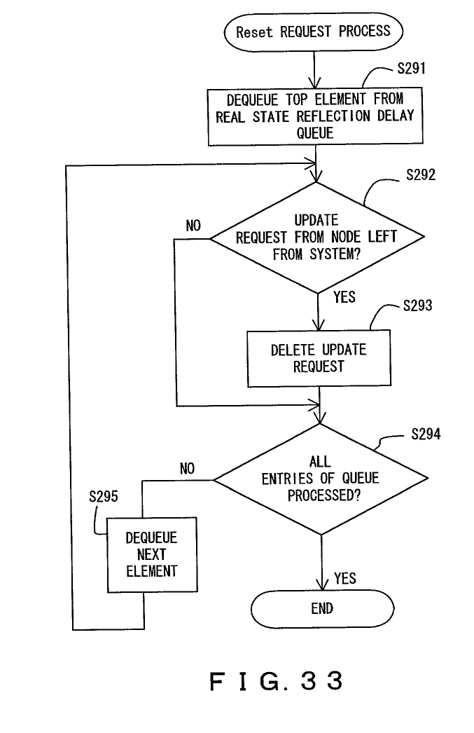

FIG. 33 is a flowchart showing the reset request process of the received data processing portion 15 at step S264 shown in FIG. 29.

In the reset request process, the received data processing portion 15 dequeues the top element from the real state reflection delay queue by judging the position from the real state reflection delay queue entry in the internal control table (at step S291). When the element has an update request of a node that has been broken away from the system (namely, the judgment result at step S292 is Yes), the received data processing portion 15 deletes the update request from the real state reflection delay queue (at step S293). When the update request is received from another node, the received data processing portion 15 does not delete the update request from the queue (namely, the judgment result at step S292 is No).

Thereafter, the received data processing portion 15 dequeues the next element from the real state reflection delay queue (namely, the judgment result at step S294 is No; at step S295). Thereafter, the received data processing portion 15 repeats the loop of step S292 to step S294. When the received data processing portion 15 has performed the process for all the elements of the queue (namely, the judgment result at step S294 is Yes), the received data processing portion 15 terminates the process.

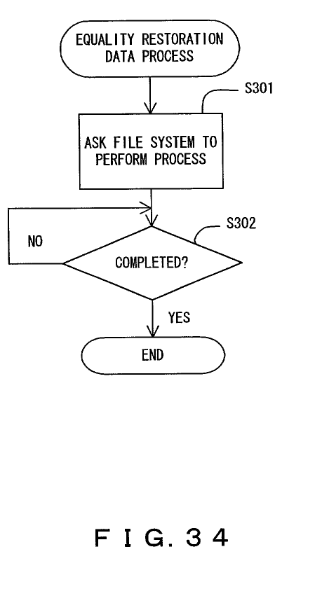

FIG. 34 is a flowchart showing the equality restoration data process of the received data processing portion 15 at step S265 shown in FIG. 29.

In the equality restoration data process, the received data processing portion 15 calls the file system (at step S301), asks it to reflect the received equality restoration transfer data on the corresponding file of the node itself, waits until the file system sends a completion message as a response message (at step S302) and then terminates the process.

[Order Assurance]

According to this system, when a file is updated, the updated content is propagated as an update request to other nodes of the system. There are three propagation modes, which are a synchronous mode, an asynchronous mode, and a semi-synchronous mode. In the asynchronous mode (other than a synchronous mode and a semi-synchronous mode), when the system is degenerated, even if a file has been updated, the updated result may be lost. As a result, when the system is degenerated, a part of data is lost, and new data and old data coexist.

According to this embodiment of the present invention, in an asynchronous mode, received updated data is enqueued in the real state reflection delay queue to prevent that. The reflection of updated data queued in the real state reflection delay queue on the files of the node itself is managed by the update number and the dependency vector so as to perform the order assurance. As a result, when the system is degenerated, old data and new data are prevented from coexisting.

The update number and the dependency vector are contained, for example, in the internal control table. The internal control table is created for each object group. Thus, the update number and the dependency vector are designated for each object group. Thus, when an object group is defined with only files that have a relationship, no order assurance of updates that do not have a relationship is performed. Thus, the overhead of the system can be reduced.

1) Update Number

An update number is a number that simply increments and represents the closed order of file updates in the node itself of the system. The update number is created for each node of each object group. Thus, whenever the IO request intercepting portion 12 receives a write request from the user program, the update number increments by 1.

2) Dependency Vector

A dependency vector is a vector that contains the update numbers of other nodes. The dependency vector represents the updates of other nodes on which update requests corresponding to update numbers depend. The dependency vector is created for each object group. The dependency vector has a number of elements corresponding to the number of nodes that belong to an object group.

A value that is always smaller by 1 than the update number of the node itself is set in an element corresponding to the node itself. When updated data is propagated, the dependency vector and the update number are added thereto.

When the node itself fails to acquire a write token and asks another node to perform a write process, the IO request intercepting portion 12 sends a write request along with the update number and the dependency vector to the requested node. The updated content of a file in the write request is sent to all the nodes of the system through the write requested node.

The read requested node adds the dependency vector to a response message.

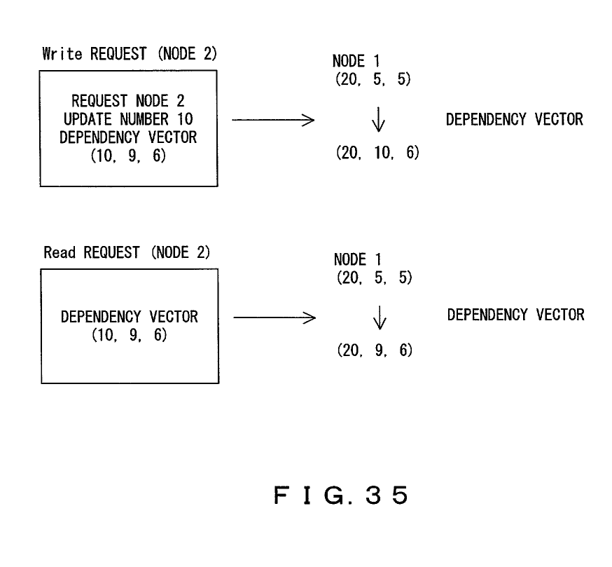

FIG. 35 is a schematic diagram showing examples of dependency vectors added to the response messages of a write request and a read request.

The first example shows the case where a system is composed of three nodes and a node 2 issues a write request to a node 1. The second example shows the case where a response message is issued in response to a read request.

When the IO request intercepting portion 12 of the node 2 receives a write request from the user program 17, the IO request intercepting portion 12 increments the update number and the part of the dependency vector corresponding to the node itself of the internal control table (namely, the update number is changed from 9 to 10 and the dependency vector is changed from (10, 8, 6) to (10, 9, 6)). The IO request intercepting portion 12 stores the incremented update number and the changed dependency vector in the write request and sends it to the node 1. In the case of a message in response to a read request, the IO request intercepting portion 12 neither increments the update number nor changes the dependency vector. Instead, the IO request intercepting portion 12 stores only the dependency vector of the internal control table to the response message without those changes.

The node 1 enqueues the updated data that is received in the case of a write request, to the real state reflection delay queue along with the update number and the dependency vector, and compares the dependency vector with the reception completion vector 22 for each element of the internal control table (the vector element corresponding to the node 2 is compared with the update numbers). When the received vector is larger than the vector of the internal control table, the IO request intercepting portion 12 of node 1 stores the received vector as a new value to the internal control table.

In the case of a message in response to a read request as the second example in FIG. 35, the IO request intercepting portion 12 of node 2 compares the dependency vector of the internal control table with the dependency vector of the response message for each element. When the received vector is larger than the vector of the internal control table, the IO request intercepting portion 12 sets the received vector as a new value to the internal control table.

Based on the dependency vector, the received data processing portion 15 judges whether an update request received from another node and updated data as a write request should be reflected on a real file. When the received data processing portion 15 has received all update requests with smaller update numbers of the dependency vector than those of all the elements of the dependency vector for each node, the received data processing portion 15 judges that the updated data should be reflected on the real file and reflects the updated data on the real file.

When there is an unreceived update request prior to the received update request, the received data processing portion 15 enqueues the received updated content to the real state reflection delay queue until the unreceived update content are sent, in preparation for discard in the restructure of a system so as to delay the reflection of the updated content on the real file. Thus, when updated contents are non-consecutively received, even if the system is restructured, no data is destroyed.

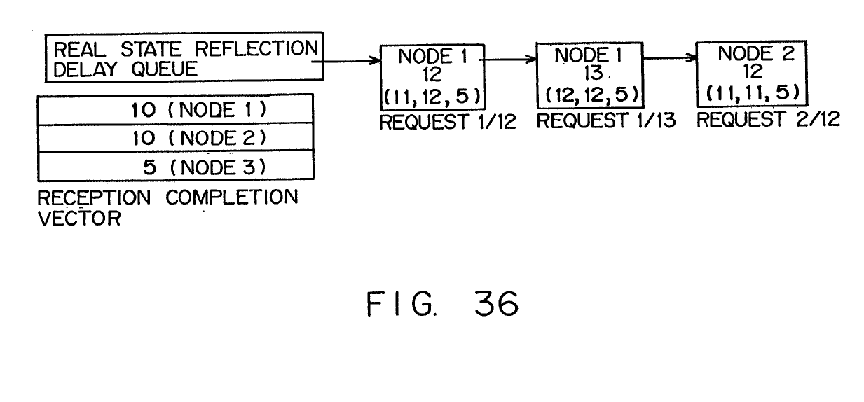

FIG. 36 is a schematic diagram showing the judgment process of the received data processing portion 15 using the dependency vector.

As shown in FIG. 36, the state of the real state reflection delay queue of the node 3 changes. An update request with the update number 12 of the node 1 (denoted by request 1/12), an update request with the update number 13 of the node 1 (denoted by request 1/13), and an update request with the update number 12 of the node 2 (denoted by request 2/12) are consecutively enqueued in the real state reflection delay queue in the order of received update requests. The reception completion vector 22 represents that updated data of up to the update number 10 has been reflected on the files themselves of the nodes 1 and 2, and that updated data of up to the update number 5 has been reflected on the files of the node 3.

It is assumed that such a state is the initial state T0 and that as the next state T1, an update request (dependency vector (10, 10, 5)) with the update number 11 of the node 2 has arrived at the node 3.

As a result, the received data processing portion 15 has received update requests of up to the update number 12 of the node 2 (the reception completion vector 22 represents that the updated data of up to the update number 10 has been reflected). Thus, the received data processing portion 15 changes the reception completion vector 22 from (10, 10, 5) to (10, 12, 5) and reflects the updated data (2/11) on the file of the node itself. However, since the update number of the node 1 of the dependency vector of the updated data (2/12) is larger than that of the reception completion vector 22, the received data processing portion 15 does not reflect the updated data on the file of the node itself, but enqueues it to the real state reflection delay queue.

For the next state T3, it is assumed that a request with the update number 11 of the node 1 (denoted by request 1/11) (dependency vector (10, 11, 5) has arrived at the node 3. Thus, since update requests of up to the update number 13 of the node 1 have arrived at the node 3, the received data processing portion 15 changes the reception completion vector 22 from (10, 12, 5) to (13, 12, 5), reflects the requests (1/11, 1/12, 1/13, and 2/12) on the real file of the node 3, and deletes those requests from the real state reflection delay queue.

When the received data processing portion 15 processes a read request, if data corresponding to the real state reflection delay queue has been enqueued, the received data processing portion 15 gets data from the element on the queue with priority and sends it to the calling portion. At that point, a dependency vector in the element is also entered to the response.

Thus, even if update requests arrive irrespective of the updated order, the received data processing portion 15 can consecutively update data in the updated order.

To omit a process for getting data from the real state reflection delay queue for simplicity, the received data processing portion 15 may wait until all data that have dependent relationships with a write request arrive at the node itself, based on the dependency vector with the write request. In this case, the received data processing portion 15 may reflect updated data corresponding to the write request on the file of the node itself and release a write token using the write token. As a result, the received data processing portion 15 may delay the reflection of updated data on the file of the node itself until the received data processing portion 15 can confirm that all update dependent data arrive at the node itself. This operation will be described later.

In such a structure, since in reading the data of the node itself, the dependent data has been reflected on the node itself after a write token is released, the process for getting data from the real state reflection delay queue and sending the data as a response message can be omitted. However, in such a case, to prevent the order of data from becoming incorrect due to the restructure of the system, a process for delaying the reflection of updated data on the real file using the real state reflection delay queue is required.

3) Update Timing of Dependency Vector

The dependency vector is updated at the following timings.

a) In case a write request is sent from another node

The received data processing portion 15 sets the received update number in an element corresponding to the requesting node of the dependency vector of the node itself.

b) In case the IO request intercepting portion 12 sends a read request to another node and receives read data as a response message

The received data processing portion 15 compares the dependency vector sent along with a response message, with the dependency vector of the internal control table for each element and stores the larger value in the internal control table. When the node itself receives a read request, the received data processing portion 15 adds the current dependency vector to a response message and send the resultant response message to the requesting node.

Since the dependency vector is propagated in such a manner, the dependency of data among a plurality of nodes can be represented. For example, in the case of update requests having the relationship represented by a (node 1)→b (node 2)→c (node 3), until the updated data of update requests a and b is propagated, update request c is not reflected.

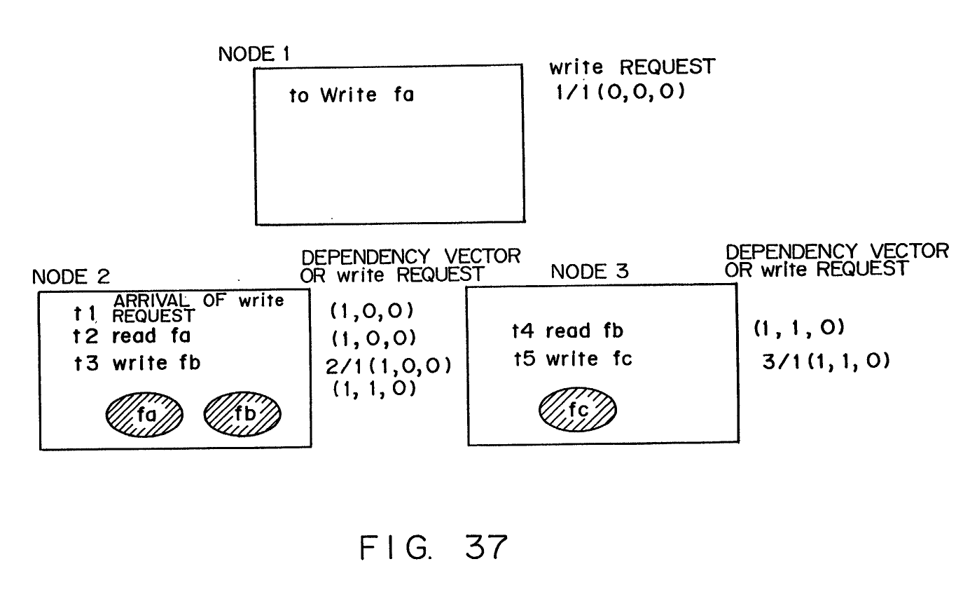

FIG. 37 is a schematic diagram showing the order assurance of update requests that have a dependent relationship.

Dependency vectors shown in FIG. 37 represent that read/write requests take place in three nodes 1, 2, and 3 for three files fa, fb, and fc that belong to the same object group. When the files are updated in the order from t0 to t5, dependency vectors that are added to update requests that take place in the three states t0, t2, and t4, have the relationship of (0, 0, 0)<(1, 0, 0)<(1, 1, 0) Thus, even if the update requests arrive at each node in the incorrect order, they are reflected on files in right order.

4) At the time of Reference Request

When the node itself asks another node to issue a read request in response to a read request of the user program 17, the IO request intercepting portion 12 does not send the referenced result to the user program 17 until the IO request intercepting portion 12 receives all dependent update requests represented by the dependency vector contained in the received data.

Since data is synchronized in the system in such a manner that response messages to the user program 17 are delayed, even if the system is restructured, data referenced by the user program 17 of the node itself that is alive can be prevented from being lost. As a result, the user program 17 can be prevented from malfunctioning.

Alternatively, to simply perform a process for sending a message in response to a read request to another node, after changed data of the node itself are propagated to the majority of nodes, the received data processing portion 15 may send a response message. In such a structure, when a result is sent to another node in response to a read request, it is assured that an update request that depends on the response message is reflected on the majority of nodes of the system. Thus, even if there is an indirect relationship, such as update request a (node 1)→update request b (node 2)→update request c (node 3) among update data, when the node 2 receives read data from the node 1, the update request a has been propagated to the majority of nodes of the system. Thus, when the node 3 receives the read result from the node 2, it is assured that the update request a that has a dependent relationship with them has been propagated to the majority of nodes of the system.

In addition, using a reception completion matrix shown in FIG. 31, the collection of a write token may be delayed until update requests that have a dependent relationship with the update of the write token are propagated to all the nodes of the system.

In such a structure, a specific update request is queued in the update propagation transmission queue until other update requests that have a dependent relationship with the specific update request are propagated to all the nodes of the system. Thus, when data that is not queued in the update propagation transmission queue is sent in response to a read request, it is assured that dependent data has been propagated to all the nodes of the system.

Thus, only when the node itself sends data queued in the update propagation transmission queue in response to a read request of another node, the node itself can send a dependency vector corresponding to the response data. When the node itself sends data that is not queued in the update propagation transmission queue in response to a read request, the node itself can send a response message without a dependency vector. Since a read request node that receives a response message without a dependency vector does not change the dependency relationship, it is not necessary to update the dependency vector of the node itself. In addition, it is not necessary to wait for an update request represented by the dependency vector.

The reception completion matrix shown in FIG. 31 is a matrix created for each node. The reception completion matrix has the reception completion vectors of other nodes as the elements. The reception completion matrix represents the states of the other nodes recognized by the node itself. In the structure where the collection of a write token is delayed until update requests that have a dependent relationship with an update protected by the write token are propagated to all nodes, based on the reception completion matrix, a node that has the write token recognizes that all updates that have the dependent relationship with the update protected by the write token have been propagated to all the nodes.

Each node broadcasts the own reception completion matrix as a message to all the nodes of the system. When each node receives the message, it updates the own reception completion matrix. Each reception completion vector of the reception completion matrix is updated in the same manner as each dependency vector.

5) At the time of Data Update

When the node itself asks another node to issue a write request, the IO request intercepting portion 12 waits until previous updated data that is sent from a dependency vector (that represents the final update request queued in the update propagation transmission queue for the same file) along with a response message, arrives. Thereafter, the IO request intercepting portion 12 updates the data of the node itself.

A write request of the node itself depends on previous read/write requests thereof. By the waiting process, it is assured that the write data of the node itself has been reflected on the file of the node itself.

By the process described in paragraph 4), it is assured that all data that has a dependent relationship with received data as reference data have been reflected on the node itself. Thus, when a write request is issued, it is assured that other updated data that has a dependent relationship with the data of an update request has been reflected on the files of the node itself. The updated data is reflected on the node itself before updated data is propagated from other nodes in the same reason as described in paragraph 4). In other words, when the system is restructured, the user program 17 of a node that is alive is prevented from malfunctioning.

When updated data is directly reflected on the node itself, if old update requests for the same file arrive, the file is destroyed. In addition, update based on another update that has been reflected on the node itself may be lost when the system is restructured. To prevent such problems, with the maximum dependency vector added to responses, it is necessary to wait for updated data that has a dependent relationship with the specific update.

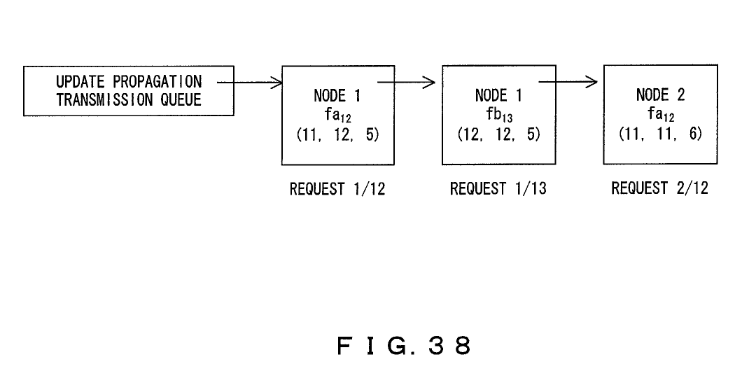

FIG. 38 is a schematic diagram showing a process in the case where when a write request of another node is processed, an update request for the same file is queued in the update propagation transmission queue.

When the node itself receives a write request for a file fa in the state of the update propagation transmission queue shown in FIG. 38, the received data processing portion 15 sends a message with a dependency vector (11, 12, 6) in response to the latest update request (request 2/12) for the same file fa to the requested node. When the update propagation delay queue does not queue a request for the same file, the received data processing portion 15 sends a response message without the dependency vector to the requested node.

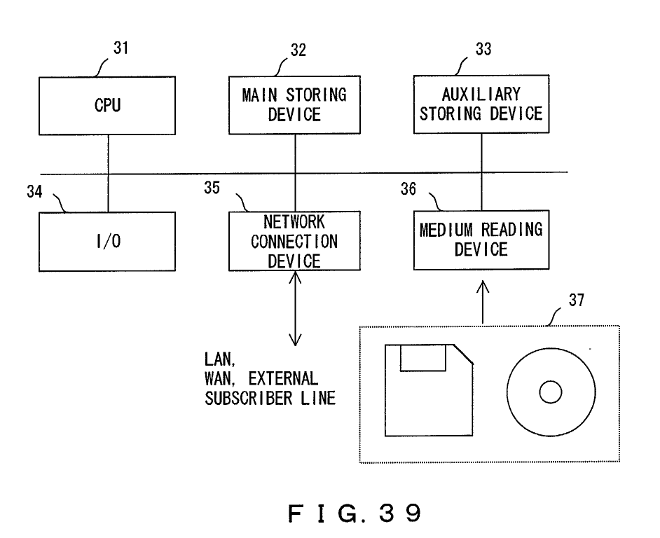

FIG. 39 is a block diagram showing the structure of each node in the case where a computer program accomplishes the file replication control according to the embodiment.

As shown in FIG. 39, each node comprises a CPU 31, a main storing device 32 (that is composed of a ROM and a RAM), an auxiliary storing device 33 (corresponding to the local disk device shown in FIG. 4), an input/output device (I/O) 34 (that is composed of a display, a keyboard, and so forth), a network connecting device 35 (such as a modem that connects the node itself to another node through a network, such as LAN, WAN, or subscriber line), and a medium reading device 36 (that reads data from a portable record medium 37, such as a disk or a magnetic tape). A bus 38 connects these structural portions.

In the information processing system shown in FIG. 39, the medium reading device 36 reads a program and data from the portable storage medium 37, such as a magnetic tape, a floppy disk, a CD-ROM, or an MO and downloads the program and data into the main storing device 32 or the hard disk 33. The CPU 31 can execute the program and data so as to accomplish each process of the embodiment as software.

Each node may exchange application software using the portable storage medium 37, such as a floppy disk. Thus, in addition to the file replication system and the file application control method, the present invention can be applied to a computer-readable storage medium 37 that causes the computer to perform the function of the embodiment.

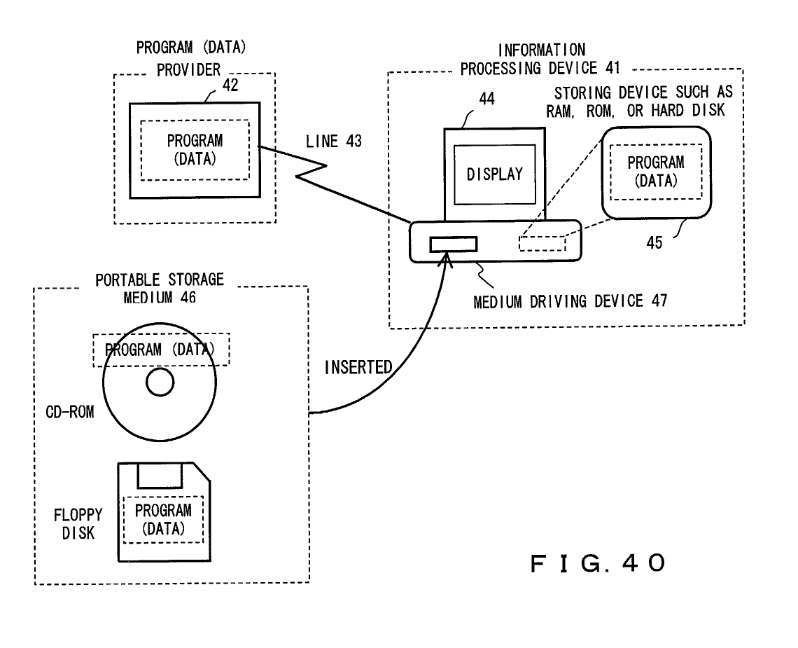

In the case, as shown in FIG. 40, the “storage medium” is, for example, a portable storage medium 46 (such as a CD-ROM, a floppy disk, an MO, a DVD, or a removable hard disk) that is attachable and detachable to/from a medium driving device 47, a storing means (database) 42 of an external device (server or the like) connected through a network line 43, or a memory (RAM or hard disk) of a main body 44 of an information processing device 41. A program recorded or stored in the portable storage medium 46 or the storing means (database or the like) 42 is loaded into the memory (RAM, hard disk, or the like) of the main body 44 and is executed.

According to the present invention, when an access request for a shared file takes place in a node, the node is notified of a node that has the latest data of the shared file. Thus, each node can always access the latest data of a shared file. In addition, since each node references the same data, it can access consistent data.

In addition, even if each node fails to acquire a token, the node can continue the process without need to wait for the token. Moreover, a plurality of nodes can simultaneously access the same file. Thus, a system having a low response latency can be accomplished.

In addition, even if an updated content is asynchronously transferred to another node, each node can access the same data.

Moreover, updated data contains information that represents the order of updates and dependency. Based on the information, a file is updated. Thus, even if the system is restructured on the way, the order of data updates is not destroyed. In addition, another node is prevented from accessing inconsistent data.

In addition, since a propagation method for an updated content and a node to which the updated content is propagated can be designated for each file based on the characteristics and performance requirements of application.

When a new node is joined to the system, an access request that takes place during the restoration process of the latest data is sent to another node that has the latest data. Thus, the newly joined node can be operated without need to wait for the completion of the restoration process. At that point, while the restoration process is being performed, the operation of a node that has been joined to the system can be continuously performed.

In the case where systematic stop in which the processes of a plurality of nodes sharing a shared file are synchronously stopped, is performed, when the processes of the nodes sharing the shared file are synchronously resumed, it is not necessary to restore the data of the shared file.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

What is claimed is:

1. A file replication system having a plurality of nodes connected to a network, shared files being distributed to the nodes, wherein
a first node of the nodes comprises:
a first token managing portion asking a second node of the nodes for an access permission for a shared file when an access request takes place in the first node, and
an IO request intercepting portion accepting an access to a shared file, the access taking place in the first node itself, asking said first token managing portion to acquire the access permission against the access request, and asking a node that has an update permission for the shared file to access to the shared file when said first token managing portion is not capable of acquiring the access permission, and
a second node comprises
a second token managing portion notifying a node that requests an access permission for a shared file of a node that has an update permission for the shared file as a response message when another node has an update permission for the shared file.

2. A node, connected to another node through a network, having a file shared with a node, comprising:
a token managing portion managing an access request for a shared file; and
an IO request intercepting portion asking said token managing portion to acquire an access permission for the shared file against an access request to the shared file in a node itself,
wherein said token managing portion notifies said IO request intercepting portion of a node that has an update permission in response to the access request of said IO request intercepting portion, and said IO request intercepting portion asks said node that has the update permission to access the shared file when said IO request intercepting portion is not capable of acquiring the access permission.

3. The node according to claim 2, further comprising:
a system structure managing portion performing a restoration process of data of a shared file of the node itself when it is newly joined to a system, wherein while said system structure managing portion is restoring the shared file, when an access request for the shared file takes place in the node itself, said IO request intercepting portion asks another node that shares the shared file to access the shared file.

4. The node according to claim 2, further comprising:
a changed data notifying portion propagating an updated content of the shared file to other node along with information that represents a dependent relationship with another update; and
a received data processing portion reflecting the updated content to the shared file while assuring an order of the update based on the dependency relationship.

5. The node according to claim 4, further comprising:
a system state information portion storing information about propagation mode of an updated content for each of at least one shared file, wherein said changed data notifying portion propagates the update content based on information queued in said system information portion.

6. The node according to claim 5, wherein the propagation mode is one of a synchronous mode in which it is assured that the updated content is propagated to all the nodes that share the shared file, a semi-synchronous mode in which it is assured that the updated content is propagated to the majority of nodes that share the shared file, and an asynchronous mode in which it is not acknowledged that the updated content is propagated to the nodes that share the shared file.

7. The node according to claim 4, wherein said system state information storing portion keeps information about each node that shares at least one shared file for each shared file.

8. A node, connected to another node through a network, having a file shared with a node, comprising:
a token managing portion asking another node to acquire an access permission for a shared file against an access request for the shared file in the node itself; and
an IO request intercepting portion accepting an access request for a shared file in the node itself, asking said token managing portion to acquire the access permission for the shared file against the access request, and asking a node that has an update permission for the shared file to access the shared file according to the access request when said token managing portion is not capable of acquiring the access permission for the shared file.

9. A node, connected to another node through a network, having a file shared with a node, comprising:
a permission request accepting portion accepting an access permission request of another node for a shared file; and
a token managing portion notifying first node that has issued the access permission request for a shared file of second node ,when the second node has an update permission for the shared file.

10. A file replication system having a plurality of nodes connected to a network, shared files being distributed to the nodes, wherein
a first node of the nodes comprises:
first token managing means for asking a second node of the nodes for an access permission for a shared file when an access request takes place in the first node, and
IO request intercepting means for accepting an access to a shared file, the access taking place in the first node itself, asking said first token managing means to acquire the access permission against the access request, and asking a node that has an update permission for the shared file to access to the shared file when said first token managing means is not capable of acquiring the access permission, and
a second node comprises:
second token managing means for notifying a node that requests an access permission for a shared file of a node that has an update permission for the shared file as a response message when another node has an update permission for the shared file.

11. A node, connected to another node through a network, having a file shared with a node, comprising:
token managing means for managing an access request for a shared file; and
IO request intercepting means for asking said token managing means to acquire an access permission for the shared file in response to an access request to the shared file in the node itself,
wherein said token managing means notifies said IO request intercepting means of a node that has an update permission in response to the access request of said IO request intercepting means, and said IO request intercepting means asks the node that has the update permission to access the shared file when said IO request intercepting means is not capable of acquiring the access permission.

12. A node, connected to another node through a network, having a file shared with the node, comprising:
token managing means for asking another node to acquire an access permission for a shared file against an access request for the shared file in the node itself; and
IO request intercepting means for accepting an access request for a shared file in the node itself, asking said token managing means to acquire the access permission for the shared file against the access request, and asking a node that has an update permission for the shared file to access the shared file according to the access request when said token managing means is not capable of acquiring the access permission for the shared file.

13. A node, connected to another node through a network, having a file shared with a node, comprising:
permission request accepting means for accepting an access permission request of another node for a shared file; and
token managing means for notifying first node that has issued the access permission request for a shared file of second node ,when the second node has an update permission for the shared file.

14. A file replication control method for a system having a plurality of nodes connected to a network, each node sharing a file, comprising:
causing an access requesting node to access a shared file of the access requesting node itself when the access requesting node has the latest data of a shared file; and
asking another node to access the shared file when said another node has the latest data.

15. The file replication control method according to claim 14, wherein
said another node that has the update permission releases the update permission after an updated content that has a dependent relationship with an update performed at said another node itself, has been propagated to all the nodes.

16. The file replication control method according to claim 15, wherein
said another node that has the update permission to release the update permission after update that has a dependent relationship with the update performed at said another node itself, has been propagated to all the nodes.

17. The file replication control method according to claim 14, wherein
said another node that has updated the shared file to asynchronously propagate an updated content to the other nodes; and
causing the node that has updated the shared file to process an access request that takes place in another node while the updated content is being propagated.

18. The file replication control method according to claim 17, wherein the updated content is reflected in such a manner that order thereof is assured.

19. The file replication control method according to claim 18, wherein
a dependency information that represents order of other updates to be propagated to the other node along with the updated content.

20. The file replication control method according to claim 19, wherein
a node that has received the updated content to reflect the updated content on a shared file of the node itself after receiving a previous updated content based on the dependency information.

21. The file replication control method according to claim 14, wherein
a propagation mode of an updated content is designated for each of at least one shared file.

22. The file replication control method according to claim 14, wherein
a node to which an updated content is propagated is designated for each of at least one shared file.

23. The file replication control method according to claim 14, further wherein
restoring data of a shared file of a newly joined node; and
operating a user program before data of the shared file is completely restored.
a node performs a restoring process that restores data of a shared file belong to the node itself when the node is newly joined to a system, and operating a user program before the data of the shared file is completely restored.

24. The file replication control method according to claim 23, wherein restored data is transmitted in such a manner that order of update requests for the shared file is assured.

25. The file replication control method according to claim 23, wherein
the node asks another node that shares the shared file to perform a process for an access request for the shared file when the access request takes place in the node itself before data is completely restored.

26. The file replication control method according to claim 14, wherein
a node that has performed a systematic stop in which nodes that share a file are synchronously stopped to store a systematic stop state and the node synchronously resumes a process for the shared file without restoring data of the shared file.

27. A file replication method for a system having a plurality of nodes connected to a network, comprising:
causing a first node to request a token for accessing a file;
notifying the first node of a second node that has the token when the first node is not capable of acquiring the token; and
causing the first node to ask the second node to access the file when the first node is notified that the first node is not capable of acquiring the token.

28. A computer-readable portable storage medium, when being used by a computer that composes a node connected to other node through a network, on which is recorded a program for causing the computer to execute a process, said process comprising:
when the node accesses a shared file and a node itself has the latest data of the shared file, causing the node itself to access the shared file of the node itself; and
when another node has the latest data, causing the node itself to ask the node to access the shared file.

29. A computer-readable storage medium for storing a program that causes a computer that composes a node connected to another node through a network to perform the steps of:
when a node issues an access request for a file shared with other node, judging whether or not a specific node has update permission for the shared file; and
when the specific node has update permission, notifying the requesting node of the specific node that has the update permission.
